(19) United States
(12) Patent Application Publication
(10) Pub. No.: US 2002/0035539 A1
(43) Pub. Date: Mar. 21, 2002

(54) System and methods of validating an authorized user of a payment card and authorization of a payment card transaction

(76) Inventor: Richard O'Connell, Dublin (IE)

Correspondence Address: Mintz, Levin, Cohn, Ferris,, Glovsky and Popeo, P.C., One Financial Center, Boston, MA, 02111, US

(21) Appl. No.: 09/907,265

(22) Filed: Jul. 17, 2001

Related U.S. Application Data
(60) Provisional application No. 60/218,590, filed on Jul. 17, 2000.

(51) Int. Cl. G06F 17/60

(52) U.S. Cl. 705/39

(57) ABSTRACT

A system and methods of validating the identity of payment card users and authorizing payment card transactions is provided. The methods of validating the identity of payment card users and authorizing payment card transactions include receiving information from payment card users to identify and validate their status as authorized payment card users. Receiving information from payment card users includes receiving information via mobile telephone, wherein payment card users provide such identifying information as a mobile telephone number, a personal identification number, an account number and or a vocal password by a mobile telephone to validate their status as authorized payment card users. Upon verification of the identifying information and an authorization status of payment card users, payment card transactions are approved. The system comprises a central manager including a database to record and store information identifying a plurality of payment cardholders and authorized payment card users. The central manager is coupled to a Short Message Service module to forward text messages to payment cardholders via mobile telephone, and further coupled to a Voice Recognition module and Interactive Voice Recognition to provide voice communication between the central manager and payment cardholders and payment card users via mobile telephone.

### CLAIM OF PRIORITY

This application claims priority under 35 U.S.C. §119(e) to U.S. provisional patent application Serial No. 60/218,590, filed on Jul. 17, 2000, which is incorporated herein by reference.

### FIELD OF THE INVENTION

The invention provides a system and methods for authorizing a transaction enacted by a payment card and validating the identity of a card user as an authorized payment cardholder. In particular, the system and methods of the present invention for validating the card user and authorizing a payment card transaction require participation of the card user in the validation and authorization process, wherein the card user must provide specific information to verify their identity as the authorized cardholder and to enable the authorization of the payment transaction to proceed.

### BACKGROUND OF THE INVENTION

A conventional payment card, such as a credit, debit or prepaid card, is typically a planar rectangular piece of plastic material on which is marked a unique identification number, an expiration date of the card and the name of a subscriber. The payment card usually has a magnetic stripe on a back surface that includes other information. In addition, banking information may also be recorded on either surface of payment cards. Other payment cards, known as smart cards, have a chip enhancement on a front surface on which the card number is recorded.

To use a payment card for withdrawal of funds from an account of a cardholder, a personal identification number or code (PIN) is issued to the cardholder for the cardholder's knowledge only. When the payment card is used, for instance, in an automatic teller machine (ATM) for withdrawal of cash or other transaction, the card is first inserted into the terminal of the ATM. The terminal reads the information stored on the card, such as the banking identification number (BIN), the cardholder's account number, the expiration date of the card and other relevant information. The ATM then requests the cardholder to key in on a keypad their issued PIN code. A verification procedure then takes place to ensure that the BIN, the account number and the PIN correspond to the same cardholder. This verification procedure may require the BIN, the account number and the PIN to be transmitted to a central database if a record of the card is not stored in the ATM. If the verification procedure is not carried out satisfactorily, then the transaction is aborted. If the transaction is unsuccessfully repeated after a predetermined number of attempts, the card is typically retained by the ATM.

During payment card transactions that do not require PIN codes, such as credit card transactions, information retrieved from a payment card is typically sent for online authorization of a credit balance and verification of lost/stolen status of the card. A merchant visually inspects and verifies the signature of a cardholder on the payment card with the signature provided by the cardholder on a payment slip or transaction receipt. When payment card imprinters are used, the merchant may decide to telephone for authorization and verification of credit worthiness and card validity having initially checked the cardholder's signature. However, if the card is being used by someone other than the authorized cardholder, the card issuer or issuing bank and the cardholder may not be aware of such unauthorized use. Significant time may elapse before the card issuer or the cardholder are aware or informed of the fact that the card is missing, lost or stolen. Only at such time will use of the card be blocked and the card placed on a “hot list” designating missing, lost or stolen cards.

New payment cards are typically sent by card issuers or issuing banks through a mail or postal service to applicants' registered addresses. Applicants typically need only sign payment cards upon receipt for use of the new cards. Often further validation of the cardholders is required. Should issued payment cards become stolen by third parties, their unauthorized use is not prevented if only a signature on a payment card is required for use. Often loss or theft of new payment cards, as well as unauthorized use of new payment cards, may not be discovered by cardholders and issuing banks nor reported to “hot lists” to deny authorization for several weeks. Such events are contributing factors to the ever-increasing amounts of money that are defrauded from merchants and banks.

In addition, skimming and counterfeit payment cards are an increasingly common occurrence. Merchants often cannot distinguish between genuine payment cards and counterfeit payment cards. Similarly, use of payment cards that have been skimmed or counterfeited may not be discovered by cardholders or issuing banks for several weeks, resulting in significant losses to merchants and banks.

Therefore, an electronic method is desired that validates the identity of an authorized cardholder upon activation or acknowledgment of receipt of a new payment card by the cardholder to prevent fraudulent use of the payment card by an unauthorized party for payment transactions. In addition, a method of validating the identity of the card user is desired prior to each occasion the payment card is used for a payment transaction to prevent fraudulent use of a lost or stolen card by an unauthorized party. It is desired that such methods of validating the identity of an authorized payment cardholder and authorizing payment card transactions provide real time validation and authorization.

### SUMMARY OF THE INVENTION

Embodiments of the invention are directed to a system and methods of validating the identity of a payment card user and authorizing payment card transactions.

In a first embodiment, the invention includes a system for providing information to identify and authorize a payment card user in a payment card authorization system comprising a central manager including a database to record and store information identifying a plurality of payment cardholders and payment card users of the authorization system. The central manager is coupled to a Short Message Service module to forward text messages to payment cardholders via mobile telephone. The central manager is further coupled to a Voice Recognition module and an Interactive Voice Recognition module for voice communication between the central manager and payment cardholders and payment card users via mobile telephone. In addition, the central manager may be further coupled to one or more credit authorization systems. In one embodiment, the central manager operates as a software module operating on one or more computers.

In a second embodiment, the invention includes a method for providing security to payment card transactions comprising receiving information designating an account of a payment cardholder. In response to receiving account information, the method includes forwarding a request over a communications system to a mobile telephone of the payment cardholder for information identifying one or more authorized users of a payment card, and then receiving information identifying one or more payment card users from the mobile telephone of the payment cardholder. In response to receiving payment card user identifying information, the method further includes creating a validation record associated with the payment cardholder account and one or more authorized payment card users and, thereafter, setting the validation record to authorize payment card transactions with use of a payment card by an authorized payment card user. In one embodiment, the communications system includes a short messaging service using a short messaging transport protocol for forwarding a request to a mobile telephone of a payment cardholder as a text message.

The method further includes receiving information designating an account of a payment cardholder from an access device selected from the group consisting of a land-based telephone, a personal computer, a personal digital assistant, an automated teller machine (ATM) and an Internet access device.

In one embodiment of this method according to the invention, receiving information identifying one or more payment card users includes receiving a verbal password associated with one or more authorized payment card users. In other embodiments, receiving information identifying one or more payment card users includes receiving a verbal password and a personal identification code associated with one or more authorized payment card users, or receiving a verbal password, a personal identification code and a mobile telephone number associated with one or more authorized payment card users.

In one embodiment of this method according to the invention, creating a validation record includes recording a verbal password associated with one or more authorized payment card users, and setting the validation record includes verifying a verbal password provided by a payment card user is similar to a verbal password recorded in the validation record and associated with one or more authorized payment card users.

In one embodiment, creating the validation record further includes creating a validation record in a database. In this embodiment, the method may further comprise providing access by a payment cardholder to the database, receiving information from the payment cardholder, and storing the information in the database. Receiving information from a payment cardholder and storing the information in the database in one embodiment includes receiving and storing information in the database for pre-authorizing or, alternatively, for blocking one or more payment card transactions of one or more authorized payment card users for a predetermined period of time. In another embodiment, receiving information from a payment cardholder and storing the information in the database includes receiving and storing information in the database for pre-authorizing one or more payment card transactions of one or more authorized payment card users within a predetermined transaction value limit. In another embodiment, receiving information from a payment cardholder and storing the information in the database includes receiving information from a mobile telephone.

In a third embodiment, the invention includes a method for authorizing payment card transactions comprising receiving information designating an account of a payment card transaction, and, in response to receiving account information, forwarding a request over a communications system to a mobile telephone of the payment cardholder for information identifying one or more payment card users. Upon receiving information identifying one or more payment card users from the mobile telephone of the payment cardholder, the method includes retrieving a validation record associated with the cardholder account and one or more authorized payment card users. The method further includes determining whether a status of a payment card user is one of authorized and unauthorized by reconciling information received identifying one or more payment card users with the validation record, and completing the payment card transaction according to an authorization status of the payment card user. In one embodiment, the communications system includes a short messaging service using a short messaging transport protocol for forwarding a request to a mobile telephone of a payment cardholder as a text message.

The method further includes receiving information designating an account of a payment card transaction from an access device selected from the group consisting of a land-based telephone, a personal computer, a personal digital assistant, automated teller machine (ATM) and an Internet access device.

In one embodiment of the method of authorizing payment card transactions according to the invention, receiving information identifying one or more payment card users includes receiving a verbal password associated with one or more authorized payment card users. In other embodiments, receiving information identifying one or more payment card users includes receiving a verbal password and a personal identification code associated with one or more authorized payment card users, or receiving a verbal password, a personal identification code and a mobile telephone number associated with one or more authorized payment card users.

In one embodiment of this method according to the invention, creating the validation record further includes creating a validation record in a database. In this embodiment, the method may further comprise providing access by a payment cardholder to the database, receiving information from the payment cardholder, and storing the information in the database. Receiving information from a payment cardholder and storing the information in the database in one embodiment includes receiving and storing information in the database for pre-authorizing or, alternatively, for blocking one or more payment card transactions of one or more authorized payment card users for a predetermined period of time. In another embodiment, receiving information from a payment cardholder and storing the information in the database includes receiving and storing information in the database for pre-authorizing one or more payment card transactions of one or more authorized payment card users within a predetermined transaction value limit. In another embodiment, receiving information from a payment cardholder and storing the information in the database includes receiving information from a mobile telephone.

In one embodiment of the method of authorizing payment card transactions, completing payment card transactions according to an authorization status of the payment card user includes notifying the payment cardholder of the status of the payment card user. In one embodiment, notifying the payment cardholder of the status of the payment card user includes forwarding a text message to a mobile telephone of the payment cardholder by a short message service using a short messaging transport protocol.

### BRIEF DESCRIPTION OF THE DRAWINGS

For a better understanding of the invention, reference is made to the drawings which are incorporated herein by reference and in which:

FIG. 1 is a functional block diagram of a Payment Card Authorization (PCA) system according to the invention.

FIG. 2 is a functional block diagram of points of access to the PCA system.

FIG. 3 is a flow diagram of a prior art method of authorizing a payment card transaction.

FIG. 4a is a flow diagram of a method of operating the PCA system for validating an authorized payment card user and authorizing a payment transaction according to the invention.

FIG. 4b is a flow diagram of a method of creating and setting a validation record with the PCA system according to the invention.

FIG. 4c is a flow diagram of a Registration Process of the PCA system providing a method of registering a payment card account with the PCA system for a type of transaction authorization.

FIG. 4d is a flow diagram of a Call Back Process of the PCA system providing a method of completing the Registration Process of FIG. 4c.

FIG. 4e is a flow diagram of a method of forming electronic text messages of transaction details of the PCA system.

FIG. 5 is a flow diagram of a method of the PCA system for authorizing a payment transaction received from a point-of-sale device according to Blocking Functions selected and activated by a subscriber.

FIG. 6 is a flow diagram of a method of the PCA system for verifying the existence of a subscription of a payment card user.

FIG. 7 is a flow diagram of a method of selecting and activating an All Transactions Function of the PCA system for authorization of payment transactions.

FIG. 8 is a flow diagram of a method of selecting and activating a Pre-Authorization Function of the PCA system for pre-authorization of payment transactions.

FIG. 9 is a flow diagram of a method of selecting and activating a Pre-Blocking Function of the PCA system for pre-blocking authorization of payment transactions.

FIG. 10 is a flow diagram of a method of selecting and activating a Standing Order Function of the PCA system for authorization of payment transactions associated with a standing order.

FIG. 11 is a flow diagram of a method of selecting, setting and activating various functions of the PCA system.

FIG. 12 is a flow diagram of a method of authorizing a payment transaction according to the Pre-Authorization Function of FIG. 8.

FIG. 13 is a flow diagram of a method of blocking a payment transaction according to the Pre-Blocking Function of FIG. 9.

FIG. 14 is a flow diagram of a method of deactivating the PCA system.

FIG. 15 is a flow diagram of a method of diverting a request for authorization of a payment transaction when the PCA system is deactivated.

FIG. 16a is a flow diagram of a method of entry of a PIN code into the PCA system.

FIG. 16b is a flow diagram of a method of entry of a number into the PCA system.

FIG. 16c is a flow diagram of a method of entry of a value into the PCA system.

FIG. 17 is a flow diagram of a method of Fraud Notification of the PCA system.

FIG. 18 is a flow diagram of a method of the PCA system for authorizing a payment transaction in a “Card Not Present” environment.

FIG. 19 is a flow diagram of a method of the PCA system for authorizing a payment transaction in a “Card Present” environment.

### DETAILED DESCRIPTION OF THE INVENTION

Illustrative embodiments of the invention described below provide a Payment Card Authorization (PCA) system and methods of validating the identity of a user of a payment card prior to use of the payment card and authorizing the payment card transaction. The PCA system and methods of the invention provide a validation transaction in which the payment card user participates in verification of their identity and authorization of payment card use. The validation transaction requires contacting the payment card user in order that the payment card user can provide cardholder or account information necessary to verify their identity as an authorized card user. The PCA system and methods of the invention are particularly suited for operation with a cardholder's mobile telephone to initiate and complete the cardholder validation process and payment transaction authorization, and are described below in reference to a mobile telephone.

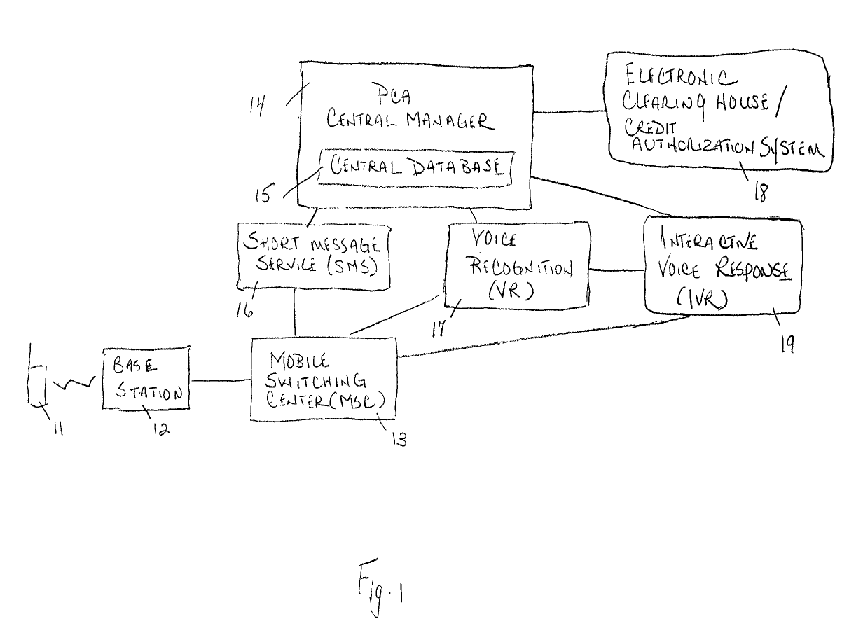

Embodiments of the invention are described with reference to FIGS. 1-19 which are presented herein for the purpose of illustrating embodiments and are not intended to limit the scope of the invention. As used in FIGS. 1-19, the term “PIN” refers to a PIN code and a vocal password when used in reference to a validation transaction.

FIG. 1 shows a functional block diagram of a Payment Card Authorization (PCA) system (10) providing cardholder verification and payment card transaction authorization in accordance with a first embodiment of the invention. The PCA system includes at least one mobile telephone (11), a base station (12), a mobile switching center (13) and a PCA central manager (14). The PCA central manager includes a central database (15) coupled with a Short Message Service (SMS) module (16), a Voice Recognition (VR) module (17) and an Interactive Voice Response (IVR) module (19). In one embodiment of the invention, the PCA central manager is implemented as a software module operating on one or more computers that perform various functions relating to verification of a plurality of payment cardholders or card users and to authorization of payment card transactions. The PCA central manager is also coupled to other electronic clearing houses or credit authorization systems (18) employed by a card issuer, such as a bank or other financial services provider, to authorize payment card transactions.

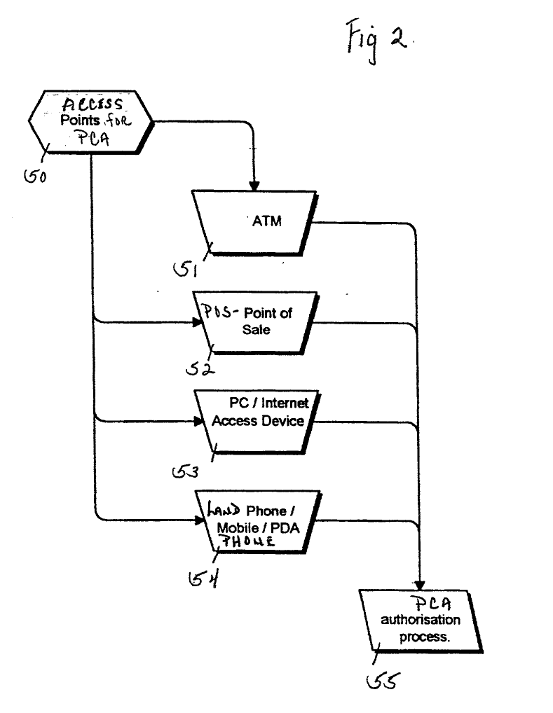

Referring to FIG. 2, in other embodiments of the PCA system according to the invention numerous access points (50) are used to access and activate the PCA system, including, although not limited to, an automatic teller machine (ATM) (51), a point-of-sale device (POS) (52), a personal computer or an Internet access device (53), i.e. a web kiosk, a land-based or mobile phone, or a personal digital assistant (54). In addition, the access points (50) are used to initiate and complete the processes of validation of a card user's identity and authorization of a payment card transaction with the PCA system (55), as described below in further detail.

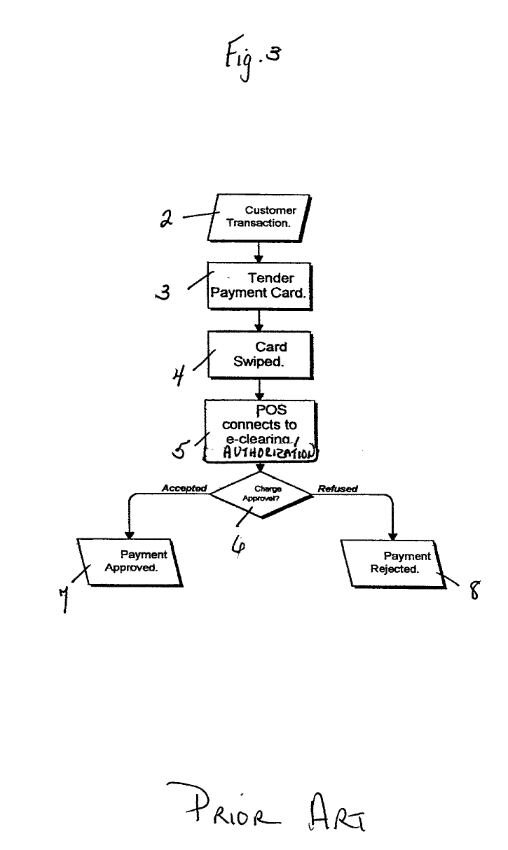

Referring to FIG. 3, a prior art method of approval of a customer transaction (2) enacted by a payment card is typically initiated by the card user tendering the payment card or an account number (3). In a “card present” environment in which the payment card is tendered, the card is swiped (4) or the card account number is keyed into an electronic payment gateway at a point of sale (POS). The POS electronically transfers the card information to an electronic clearing house or credit authorization system (5) used by a card issuing bank or other financial services provider. In a “card not present” environment in which only an account number is tendered, a card's identification information is electronically transferred at the POS to the electronic clearing house. The clearing house either approves or rejects the payment card transaction by verification of the account number, its expiration date and its credit limit (6). If all information is verified, the payment transaction is approved by the electronic clearing house providing an authorization code to a merchant or retailer (7). If all information is not verified, the payment transaction is rejected (8). The prior art method of approval of the payment transaction illustrated in FIG. 3, however, does not verify the identity of the card user. The card user may not be the authorized cardholder to whom the payment card was issued nor authorized by the cardholder to use the payment card. Such prior art method of approval of the payment card transaction, therefore, does not prevent use of the payment card by an unauthorized party.

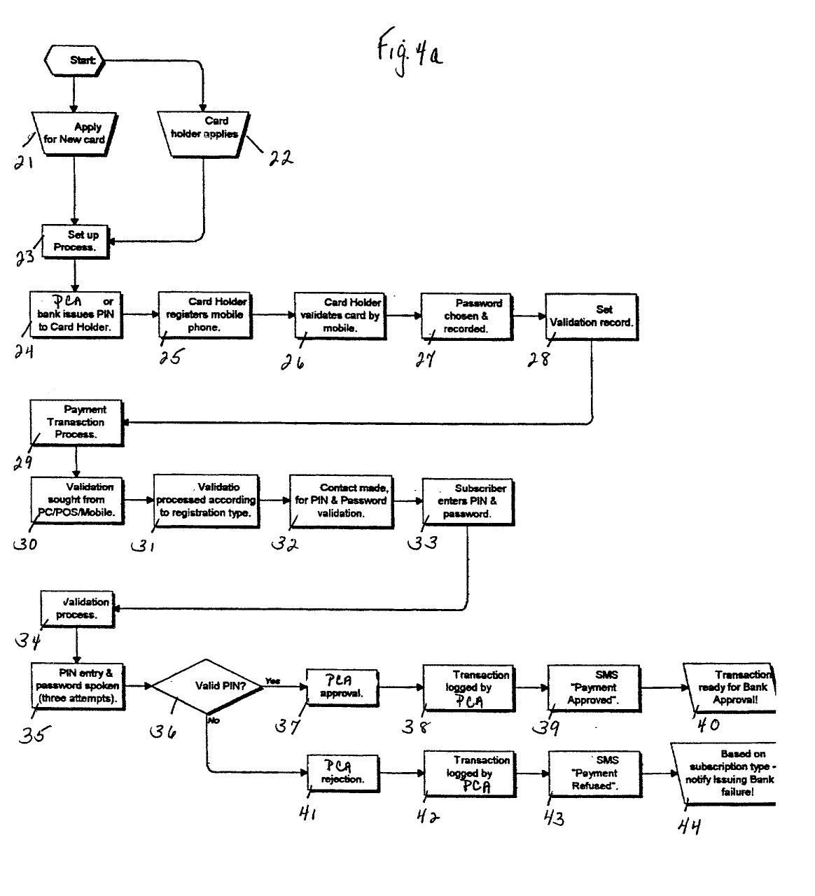

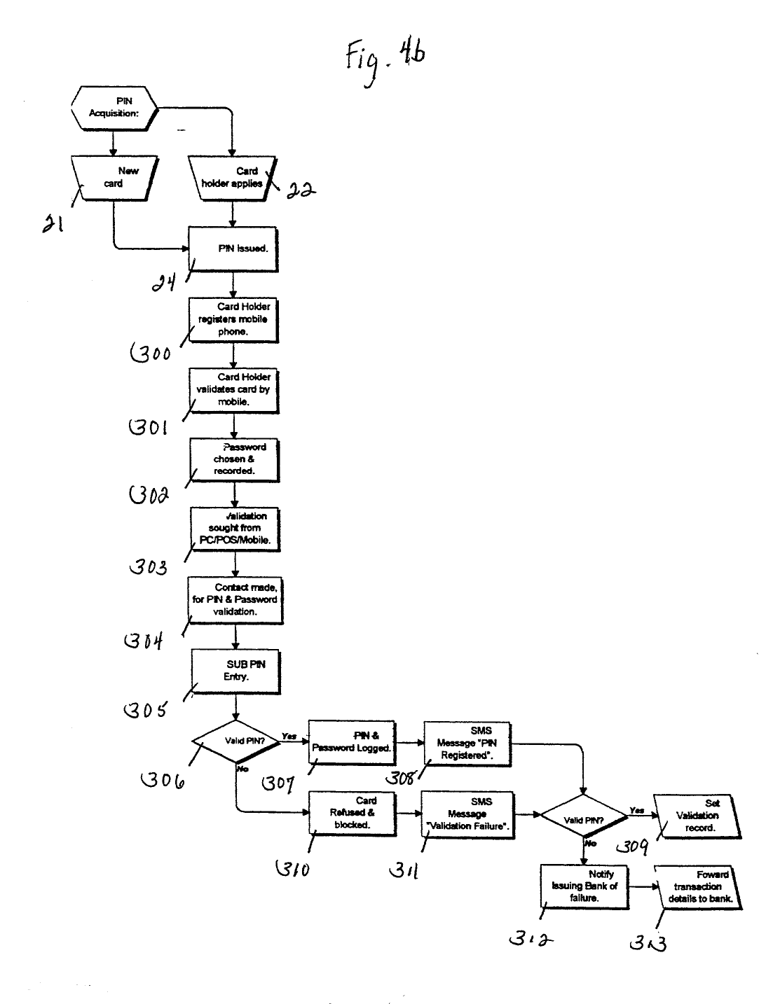

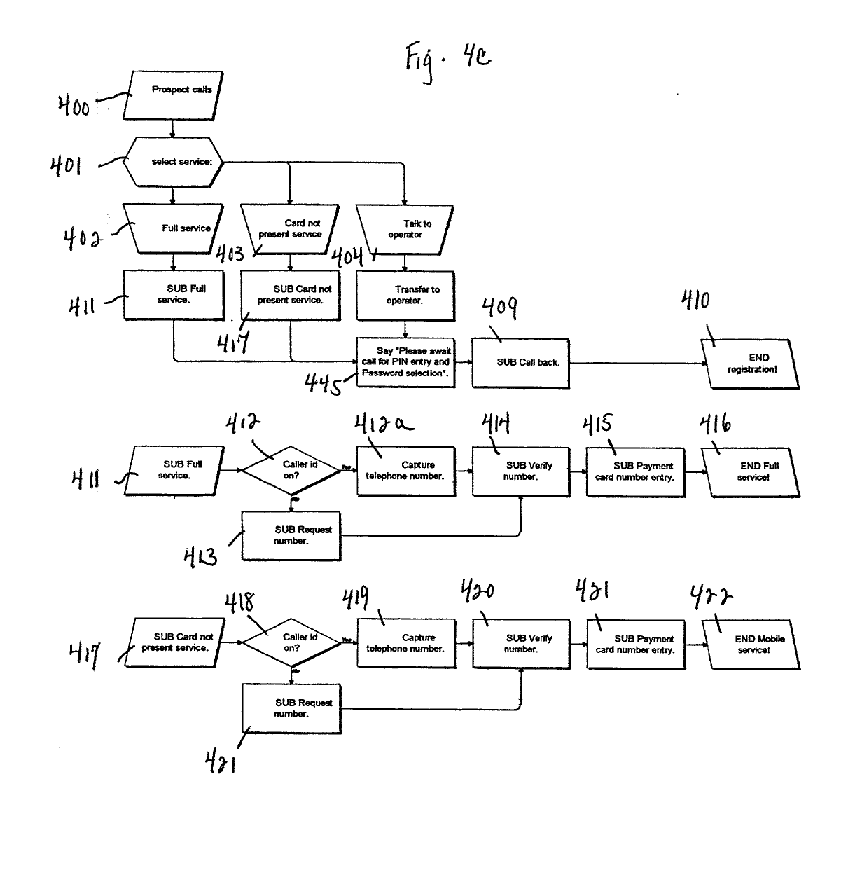

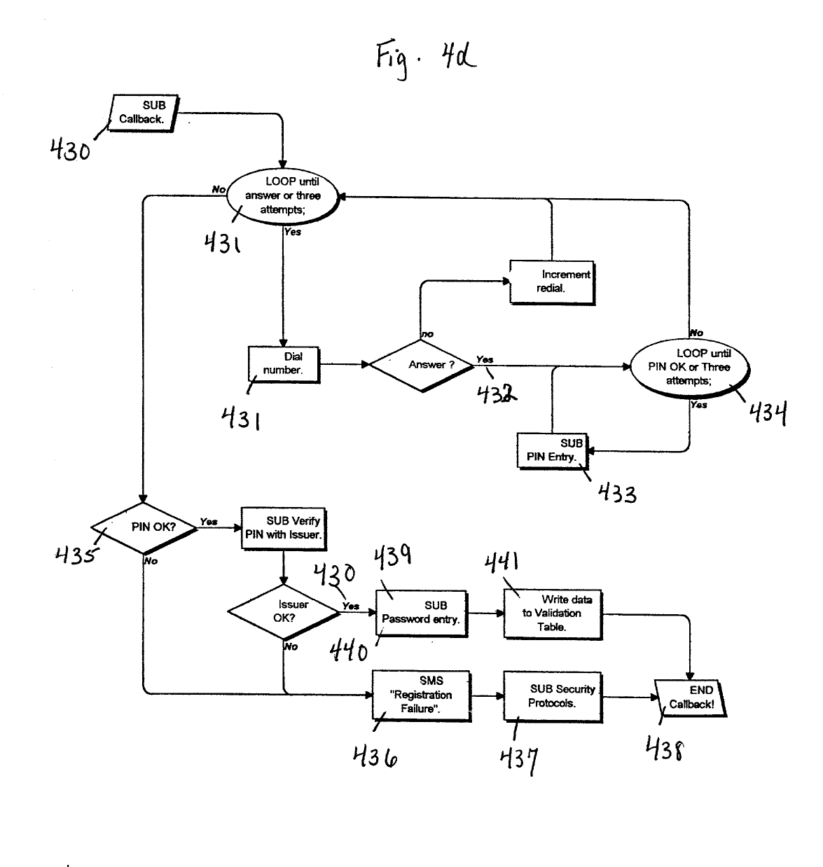

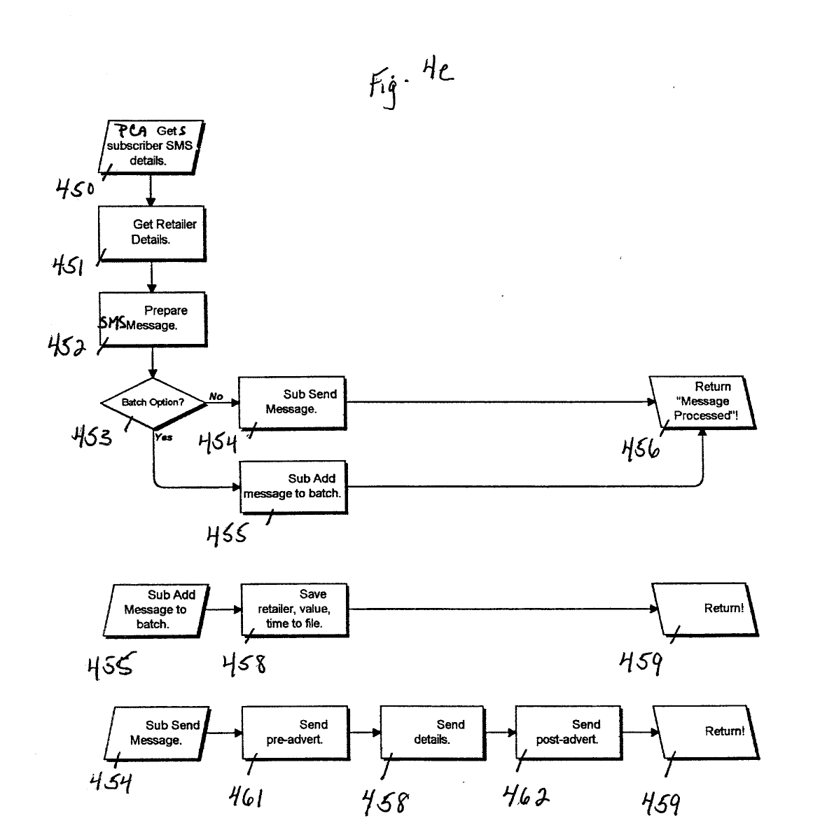

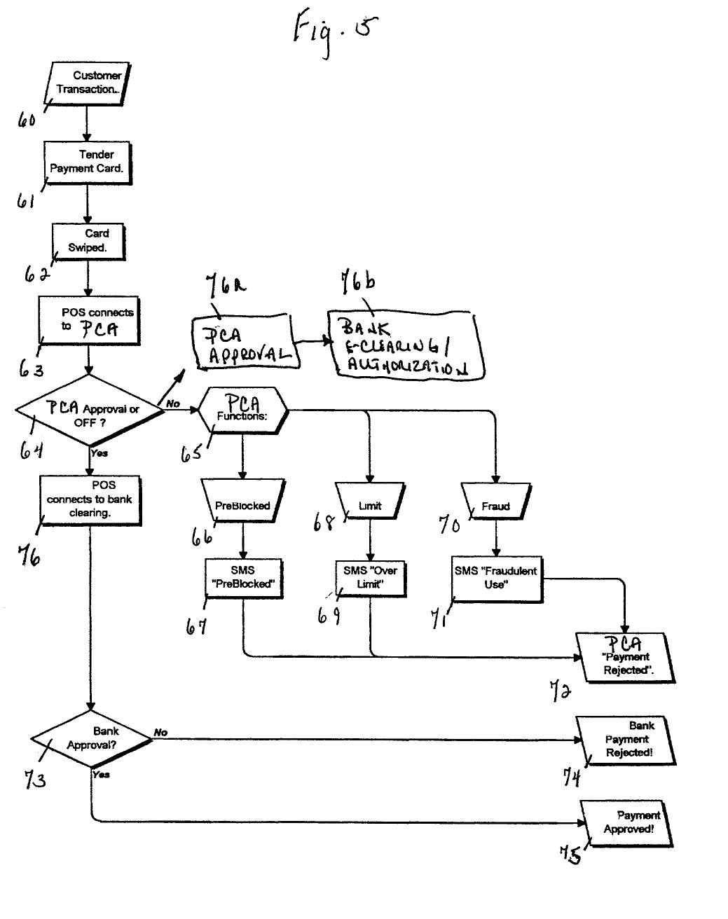

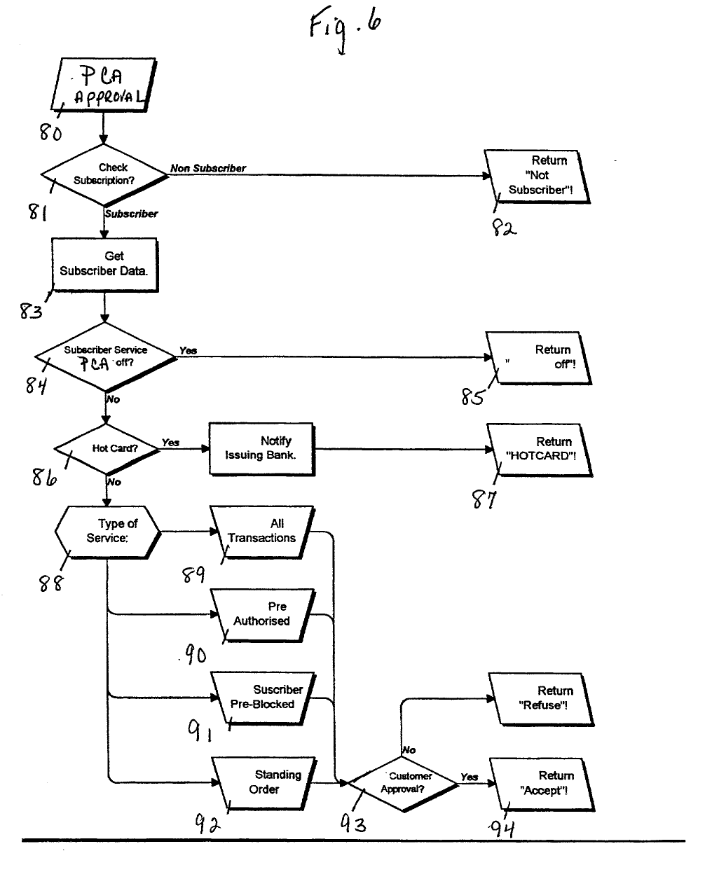

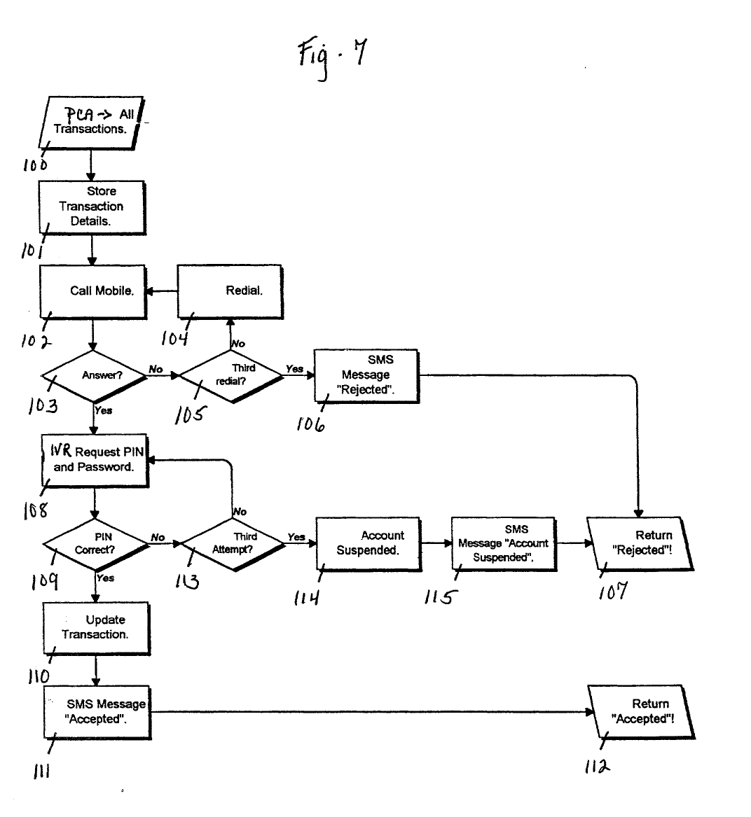

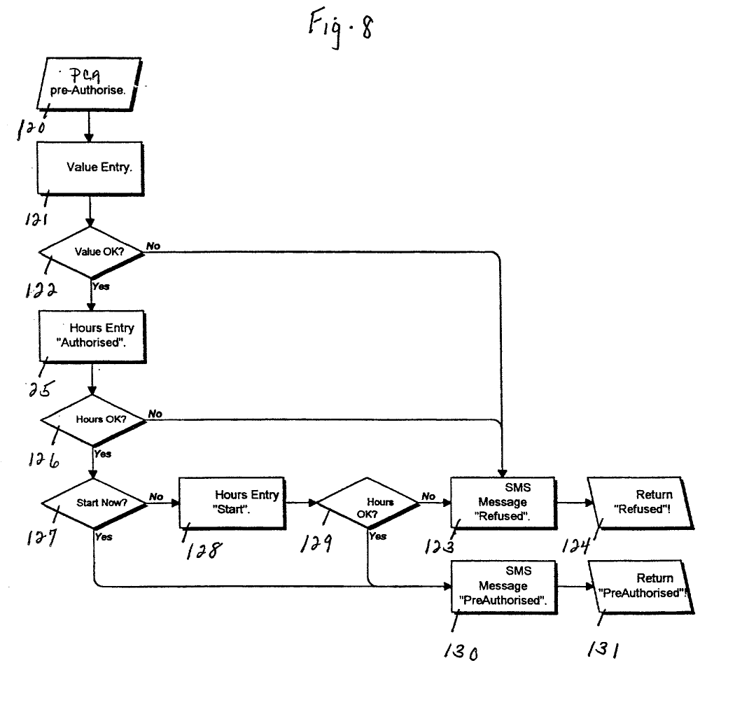

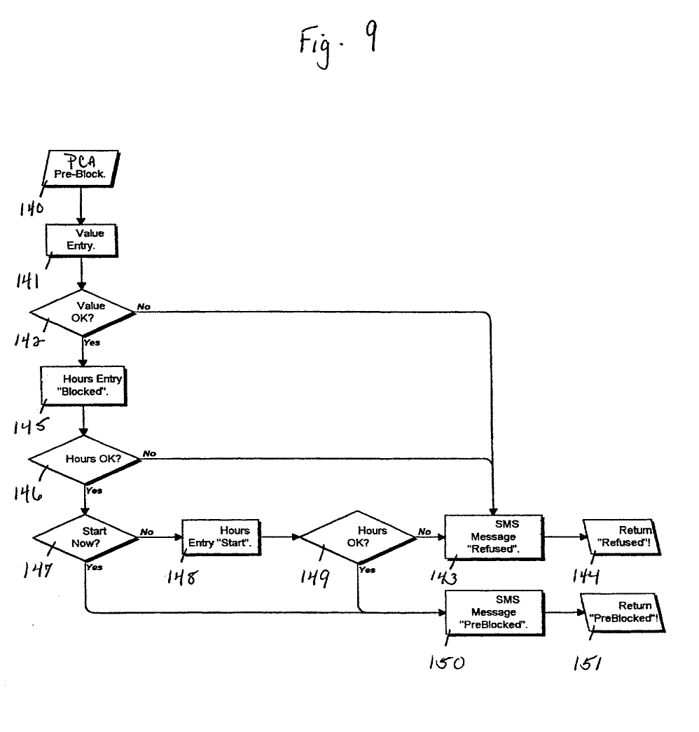

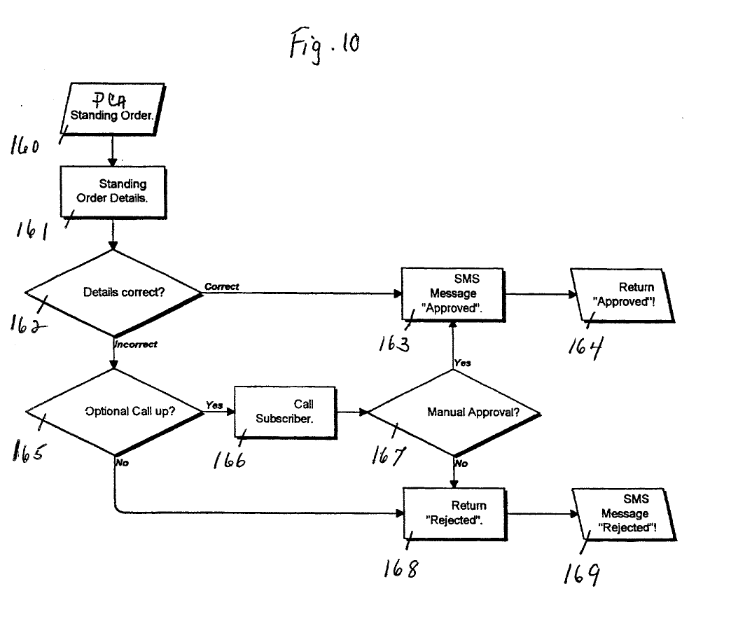

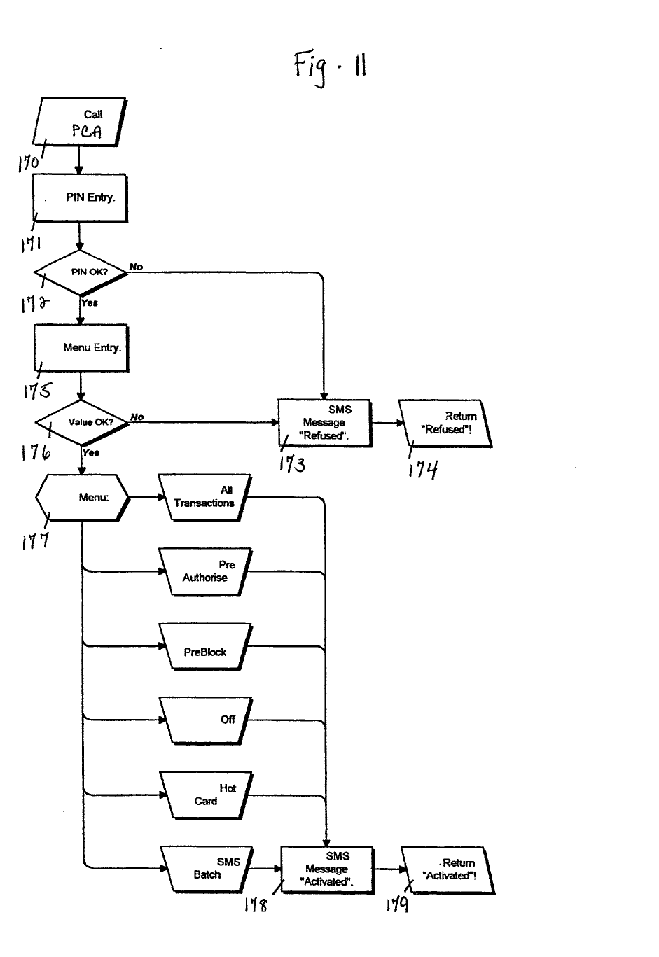

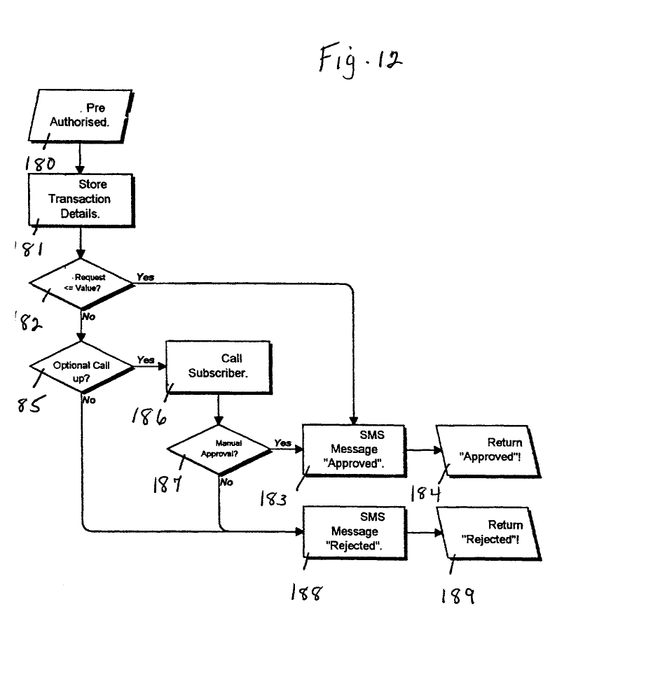

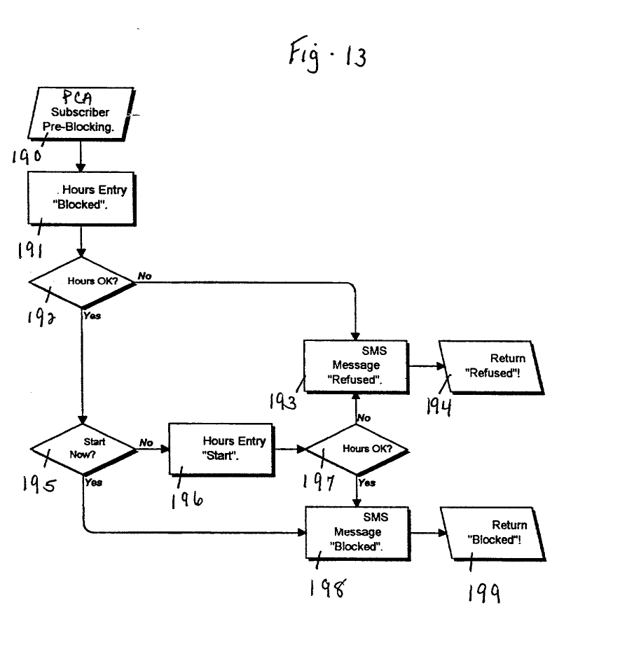

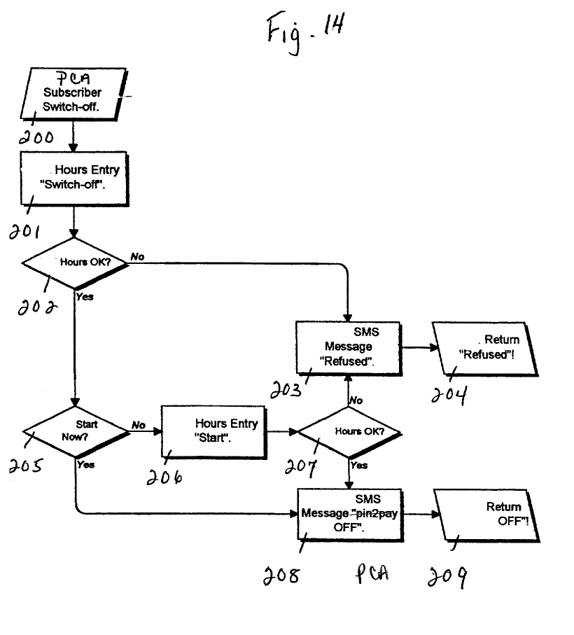

Referring to FIGS. 4a-4e, a second embodiment of the invention provides a method of operating the PCA system (10) for validating an authorized card user and authorizing payment of a payment card transaction using a mobile telephone. The method initiates upon approval of a new subscriber by the PCA system or a payment card issuer, such as a bank or other financial services provider, wherein a Set Up Process initiates upon registration or first use of a payment card; a Validation Process creates and sets a validation record with the PCA system; a Registration Process selects and registers one or more Payment Authorization Functions chosen by a subscriber; a Call Back Process, a subprocess of registering for a Payment Authorization Function, to confirm registration; and a Short Messaging Service formulates text messages to the subscriber or card user to indicate process and authorization status.

As shown in FIG. 4a, a prospective subscriber of the PCA system applying for a new payment card initiates an application process with a payment card issuer for a payment card, such as, although not limited to, a credit card, a debit card or a prepaid payment card (21). In one embodiment, the payment card issuer may be a subscriber of the PCA system, incorporating the PCA system and methods according to the invention with other authorization systems and methods to authorize payment card transactions, such as an electronic clearing house. Upon is approval of the payment cardholder by the card issuer, the card issuer or the PCA system then initiates a Set Up Process (23). The Set Up Process includes the card issuer or the PCA system issuing a personal identification number (PIN code) to the newly approved cardholder (24). Typically, the card issuer or the PCA system sends the new cardholder a PIN code under separate cover from the new payment card to secure transmission of the PIN code to the intended card user.

In one embodiment, an existing cardholder may register a previously issued payment card with the PCA system as a subscriber by either applying to the PCA system or to the payment card issuer for a PIN code (22). If a PIN code has been previously issued to the existing cardholder by the card issuer, the existing cardholder may use such PIN code to initiate the Set Up Process (23) to subscribe to the PCA system. The prospective subscriber of the PCA system may access the PCA system to apply for or register a payment card and or PIN code by completing and submitting a written application to the PCA system, accessing a PCA website and completing a secure online application form or telephoning a secure registration line of the PCA system. In the mobile phone context of the second embodiment, a prospective subscriber calls the registration line of the PCA system directly from a mobile telephone to initiate the Set Up Process and the Registration Process, as described herein in further detail with reference to FIG. 4c.

The Set-Up Process further includes creating a validation record in the central database (14) maintained and operated by the PCA system (25-28). After receipt of a PIN code from the PCA system or the card issuer, the subscriber initiates the Set Up Process by registering a mobile telephone number with the PCA system (25). The subscriber may register a mobile phone number by directly calling the PCA system with a mobile phone, and entering into the PCA system the issued PIN code and account number by manually keying in such information on a keypad of a mobile phone (26). The mobile phone number and the account number are recorded by the PCA system in a validation record stored in the central database of the PCA system. After registration of the mobile phone number and account number with the PCA system, the PCA system requests the subscriber provide a vocal password that is recorded and encoded in the validation record (27). Upon receipt of the subscriber password, the PCA system completes the Set Up Process and sets the validation record in the central database (28). The Set Up Process not only initiates and completes the formation of the validation record in the central database, but simultaneously acknowledges to the PCA system and the card issuer that the new payment card and PIN code were received by the intended subscriber.

Upon tender of the payment card by the subscriber for payment of a transaction, the PCA system initiates the Payment Transaction Process (29) to obtain information from the subscriber for validation of the card user's identity. The Payment Transaction Process can acquire information from the payment card user and or the payment cardholder for validation of a transaction from various access points to the PCA system as described above, including, although not limited to, a PC, a POS device, or a mobile or land-based telephone (30). Validation of the payment card user identity and eventual authorization of the payment transaction proceeds according to a type of registration chosen by the subscriber (31). The type of registration is selected during a Registration Process described herein in further detail with reference to FIG. 4c. Once the Payment Transaction Process initiates, the PCA system contacts the mobile phone of the subscriber (32) for verification by the subscriber of the PIN code and password. The subscriber responds by manually entering the PIN code into the keypad of a mobile phone and speaking the password into a mobile phone receiver (33).

The Validation Process then initiates (34). The PIN code and password provided by the subscriber are logged into the central database of the PCA system for verification (35). The PIN code and password are checked for validity by comparison of the PIN code and password provided by the subscriber with data stored in the validation record of the central database (36). If the PIN code and password are valid, the PCA system approves the payment transaction (37). The PCA system logs details of the approved payment transaction into the central database (38). In addition, the details of the approved PCA transaction are formulated into a text message and sent via the Short Messaging Service (SMS) (16) module to the subscriber's mobile phone (39), indicating to the subscriber that the payment transaction is approved. The PCA system also routes the approval of the transaction to the card issuer's electronic clearing house or credit authorization system (40) for further authorization including, for example, verifying payment card expiration date, available credit line and credit limit. If the PIN code and or password are not valid, the PCA system rejects the payment transaction (41). The PCA system similarly logs details of the rejected payment transaction into the central database (42) and sends an SMS message to the mobile phone of the subscriber (43) to indicate to the subscriber that the payment transaction has been refused. Depending upon the type of registration the subscriber has selected through the Registration Process with the PCA system, the card issuer may be notified of the rejection of the payment transaction (44).

Referring to FIG. 4b, a method of creating and setting the validation record with the PCA system is described in further detail. The subscriber initiates acquisition of a PIN code from the PCA system or a payment card issuer as either a new payment card applicant or an existing payment cardholder. Upon approval of the subscriber by the card issuer or the PCA system, the PCA system or the card issuer issues a PIN code to the subscriber. The Validation Process with the PCA system to create the validation record is then initiated by the subscriber. In one embodiment, an existing payment cardholder initiates the Validation Process as a subscriber using an existing PIN code previously issued by a card issuer. The PCA system registers a mobile phone number provided by the subscriber (300). The registration of the mobile phone number may be done immediately after receipt of the PIN code and the payment card or upon first use of the payment card by the subscriber.

The PCA system acknowledges safe receipt of the payment card and PIN code by the intended subscriber when the subscriber contacts the PCA system through, for instance, the registration call line connected to the PCA system. The subscriber may access the registration call line by dialing their mobile phone, or, in other embodiments, using other access points to the PCA system as described above, including an ATM, a POS device, a PC, a land-based phone or an Internet-access device. Upon request of the PCA system, the subscriber enters the PIN code and payment card number into the PCA system by manually keying such information into the key pad of their mobile phone. The PCA system logs the mobile phone number and PIN code into the validation record of the central database. The subscriber is then asked by the PCA system to provide a vocal password by speaking the password into the receiver of their mobile phone (302). The PCA system records the spoken password in the validation record, thereby completing the validation record stored in the central database. Registering the mobile phone number of the subscriber to create the validation record allows the PCA system to acknowledge that the intended subscriber has received the issued payment card and PIN code.

Upon first use of the payment card by the subscriber, the PCA system finally sets the validation record in the central database. As shown in FIG. 4b, validation of the first payment transaction is sought when the PCA system receives a request for authorization of the first payment transaction (303). The PCA system receives a request for authorization of the payment transaction from various access points other than the subscriber mobile phone, including an ATM, a POS device, a PC, a land-based phone or an Internet-access device. The PCA system contacts the subscriber by calling the mobile phone number of the subscriber for validation of the PIN code and password (304). The subscriber provides the PIN code and password (305) and the PCA system checks the validity of the PIN code and password (306). If the validity of the PIN code provided is confirmed by the PCA system, the PIN code and password provided by the subscriber are logged into the validation record (307), and the valid PIN code and password are set in the validation record (309). Upon confirmation of the validity of the PIN code, an SMS message is sent to the subscriber's mobile phone (308) indicating that the PIN code is registered with the PCA system. However, if the validity of the PIN code provided is not confirmed, the payment transaction is refused and further payment authorization is blocked or refused (310). An SMS message is sent to the subscribers' mobile phone (311), indicating that the validation process has failed. The card issuing bank or financial services provider is notified of the failure to validate the PIN code (312), and is sent the details of the failed validation and refused payment transaction (313).

The creation and setting of the validation record in the central database of the PCA system, as shown in FIG. 4b, includes at least registering the mobile phone number of the cardholder and recording the PIN code issued to the authorized cardholder and the vocal password selected by the cardholder. The validation record forms an authorization template from which all future payment transactions will be verified and authorized by the PCA system. Without verification of the validity of the PIN code and password with the validation record, the PCA system will refuse or block authorization of a payment transaction.

The method of operating the PCA system shown in FIGS. 4a-4b provides the feature and advantage of the validation transaction to verify the identity of a user of a payment card and to authorize use of the payment card via a mobile phone. The validation transaction requires the participation and involvement of the card user through use of a mobile phone in the verification and authorization processes of the PCA system. Such participation and involvement by the card user provides the advantage of added security for payment card transactions. Through the validation transaction, the PCA system contacts the card user by calling the card holder's registered mobile phone and requests a correct PIN code and vocal password, previously logged and set in a validation record of the central database to be provided via a mobile phone keypad. Entry of the correct PIN code and vocal password completes the validation transaction and identifies to the PCA system that the card user is an authorized card user. In one embodiment, the card user and the payment cardholder or subscriber to the PCA system are different individuals, wherein the payment cardholder is contacted by the PCA system to verify the identity of a card user as an authorized user of the payment card. For instance, a payment card account provides a provision for the use of a payment card by one or more authorized individuals, such as members of the payment card account holder's family.

The added security of requiring entry of the correct PIN code and vocal password by the card user enables the card issuer and the PCA system to validate or acknowledge that the payment card and the PIN code issued in conjunction with the payment card are received by the intended recipient or the authorized cardholder. The PCA system and method of validating the authorized card holder thereby provide a more secure means of distributing payment cards and PIN codes to approved payment cardholders. In addition, the added security provided by the PCA system and method of validating the authorized card holder eliminates the need for replacement payment cards and requiring approved payment cardholders to pick up new or replacement payment cards from card issuers. The PCA system and method of the invention also allow early detection of unauthorized or fraudulent use of the payment card by an unauthorized card user, since the validation or acknowledgment of receipt of a new payment card involves the validation process, wherein entry of the correct PIN code and registration of the authorized cardholder's mobile phone number are required to establish the validation record of the central database of the PCA system from which all payment transactions are authorized. Without establishing a verifiable validation record prior to first use of the payment card or validating the identity of the card user by checking the validation record, the PCA system cannot approve or authorize payment card transactions.

An authorized cardholder who fails to initially validate or acknowledge a new payment card will be asked to register the payment card immediately with the PCA system by supplying the correct issued PIN code and registering the cardholder's mobile phone number. If such information is not provided by the authorized cardholder, the payment card may be confiscated by an ATM, retained by a merchant or blocked by the PCA system when the payment card number is tendered for payment in a “card not present” environment, such as an online Internet or telephone transactions. The authorized cardholder will have the opportunity to retrieve the payment card from the card issuer, or the financial institution that confiscated the payment card in the case of an ATM transaction. The authorized cardholder would be required to enter the correct PIN into the PCA system, for instance, either by keying in the PIN code with a mobile phone, or with a land-based phone located in the financial institution that confiscated the payment card in the presence of a staff member. The authorized cardholder also has the opportunity to retrieve the payment card from the merchant who retained the payment card by keying in the correct PIN during validation and authorization of the payment transaction by the PCA system, following the swiping of the payment card in an electronic funds transfer point-of-sale device in the presence of a staff member. Finally, the authorized cardholder may unblock the payment card in the PCA system unblocking process which automatically validates payment card use thereafter.

Referring to FIG. 4c, in one embodiment, a method of registering the payment card with the PCA system for a certain type of payment authorization is offered by the PCA system. The PCA system provides different types of Payment Authorization Functions for use with the payment card to provide the subscriber with a specific level of security with respect to payment authorizations. The Payment Authorization Functions provided by the PCA system include a Full Service Authorization Function that requires the PCA system to contact the subscriber for authorization of all payment transactions including “card present” transactions and “card not present” transactions, such as online Internet transactions or keyed in Mail Order Telephone Order (MOTO) transactions. The PCA system also provides a Card Not Present Authorization Function for the subscriber who wishes to have approval by the PCA system for only “card not present” transactions, as described above. Another Authorization Registration Function provided by the PCA system includes a Talk To Operator Service Function for the subscriber who wishes to be guided through a selected type of registration.

As shown in FIG. 4c, in addition to creating the validation record, the method of registration for a specific type of Payment Authorization Function through a Registration Process is required by the PCA system. The Registration Process initiates when the subscriber contacts the PCA system (400) and a selection of Payment Authorization Functions is offered by the PCA system (401). In one embodiment, if Full Service Authorization is selected (402), the PCA system will contact the subscriber for each payment transaction seeking authorization through the PCA system including “Card Not Present” Transactions. In one embodiment, if the Full Service Authorization Function has been activated (411) and the subscriber's mobile phone caller identification (Caller ID on?) is operational (412), the PCA System captures this subscriber's mobile phone number (412a). In other embodiments, the subscriber is requested to manually key their mobile phone number into a keypad of a mobile phone (413). The PCA system verifies the mobile phone number received from the subscriber's mobile phone (414), and the subscriber is asked to key in their payment card account number into a keypad of a mobile phone (415). The Interactive Voice Response (IVR) module of the PCA system responds to the subscriber's mobile phone number and payment card number with a vocal message, such as, for instance, “Please await call for PIN entry and Password selection” (445), and the PCA System ends the call (416). Thereafter, the PCA system initiates a Call Back Process (409), described herein in further detail with reference to FIG. 4d , to complete registration of the Full Service Authorization Function with the PCA system (410).

In one embodiment, selection of the Card Not Present Authorization Function by the subscriber (403) indicates to the PCA system that the subscriber elects to receive the PCA approval only in situations in which the payment card is not physically presented, such as Internet and MOTO transactions. The process of registration for Card Not Present Authorization Function similarly proceeds as described above in reference to registration for Full Service Authorization Function (417). In one embodiment, if the subscriber's mobile phone Caller ID (Caller ID on?) is operational (418), the mobile phone number of the subscriber is captured by the PCA system (419). In other embodiments, the subscriber is requested to manually key their mobile phone number into a keypad of a mobile phone (421). The PCA system verifies the mobile phone number received (420), and the subscriber is asked to key their payment card account number into a keypad of a mobile phone (421). The IVR module responds to the subscriber with a vocal message indicating the type of registration selected (445). And the PCA system ends the call (422). The PCA Call Back Process initiates (409), as described herein in further detail with reference to FIG. 4d, and proceeds to complete the registration of Card Not Present Authorization Function with the PCA system (410).

If the subscriber selects registration of Talk To Operator Authorization Function (404), the subscriber is assisted by the PCA system through the registration process. The subscriber is guided through a registration process substantially similar to the process for the Full Service (411) and Card Not Present Authorization Function registration (417).

Referring to FIG. 4d, the Call Back Process is a sub process of the method of registration of a selected Payment Authorization Function with the PCA system. The PCA system initiates the Call Back Process by calling the subscriber's registered mobile phone number (430). Three attempts are made by the PCA system to contact the registered mobile phone number of the subscriber (431). Once the PCA system's call is answered by the subscriber (432), the PCA system requests the subscriber enter the PIN code and password (433). The PCA system provides the subscriber with three attempts to enter the correct PIN code (434). The PCA system verifies if the PIN code is valid (Pin OK?) (435). If the PIN code is invalid (No), an SMS message is sent to the subscriber's mobile phone indicating registration has failed (“Registration Failure”) (436). The PCA system's SMS message initiates certain security protocols instituted by the card issuer or issuing bank (437) and the Call Back Process ends (438). If the PIN code entered is verified by the payment card issuer (430), the subscriber is then asked to speak their chosen password into a mobile phone for verification (439) by the VR module of the PCA system. The data entered are set into the validation record of the central database of the PCA system (441) and the Call Back Process ends (438).

Referring to FIG. 4e, each occasion the PCA system is contacted for validation of a payment card user and authorization of a payment card transaction, the PCA system requires a text alert or notification that the central database align the subscriber details recorded therein in the Validation Record (450) with the retail payment transaction details (451). The PCA system then formulates the subscriber and retailer details into an SMS message (452). The SMS message is sent by the PCA system to the subscriber either immediately (454) or at a predetermined time after the payment transaction (455). The successful transmission of the SMS message(s) is confirmed by a return message to the PCA system indicating successful transmission (“Message Processed”) (456). In one embodiment, the subscriber may request the PCA system transmit an SMS message for delivery at a later time or in batches (455), wherein the payment transaction details are saved and later sent in a normal format (458). In other embodiments, advertising messages provided by merchants, retailers and other PDS entities may be attached to payment transaction SMS messages. Provisions for attachment of advertisements to SMS messages may include attachment of an advertisement preceding delivery of an SMS message (461) or attachment of an advertisement following transmission of an SMS message (462).

Referring to FIG. 5, a third embodiment of the invention provides a method of authorization of a payment card transaction by the PCA system (60), which is described herein with reference to a payment card transaction initiated by a point-of-sale (POS) device. The method of payment authorization initiates upon tender of the payment card by the subscriber (61). In one embodiment, the subscriber manually tenders the payment card to a merchant or retailer who swipes the payment card through a POS device (62). The POS device accesses or connects to the PCA system (63). The POS device indicates whether the PCA system is operational (PCA Approval) or not (“OFF”), and whether the payment transaction is approved or rejected by the PCA system (64). If the POS device indicates the PCA system is not operational (“OFF”) (64), the POS device connects either directly to the card issuer or the card issuer's electronic clearing house or credit authorization system (76) for authorization of the payment transaction (73). Depending upon a Pre-Authorization Function activated by the subscriber with the PCA system, as described below in further detail with reference to FIG. 8, the PCA system is either “Operational” for receipt of transaction details from the POS device and to provide payment approval, or “Not Operational” for direct connection of the POS device to the card issuer's authorization systems. In one embodiment, if the PCA system is “Operational” and the payment transaction has been authorized (76a), the POS device is further connected to the card issuer's other authorization system(s) for further verification to reject or approve the transaction (76b).

The PCA System also provides the subscriber with a selection of Blocking Functions that allow the subscriber to preset and tailor their involvement with the subscriber validation transaction and the payment transaction authorization (65). The Blocking Functions include, although are not limited to, a Pre-Blocking Function, a Predetermined Limit Function, and a Fraudulent Activity Function. In one embodiment, if the PCA system is activated to provide the Pre-Blocking Function, a payment transaction is pre-blocked and authorization of the transaction is not issued by the PCA system (66). An SMS message is sent to the subscriber's mobile phone by the PCA system indicating that the payment transaction is pre-blocked (67). The process of selection and activation of the Pre-Blocking Function with the PCA system is described herein in further detail with reference to FIG. 9.

In one embodiment, if the Predetermined Limit Function is activated by the subscriber in the PCA system, the PCA system does not authorize a payment transaction that is over a predetermined limit preset with the PCA system by the subscriber (68). An SMS message is sent to the subscriber's mobile phone indicating that the PCA system has been contacted for authorization of a payment transaction that is over the predetermined limit (69).

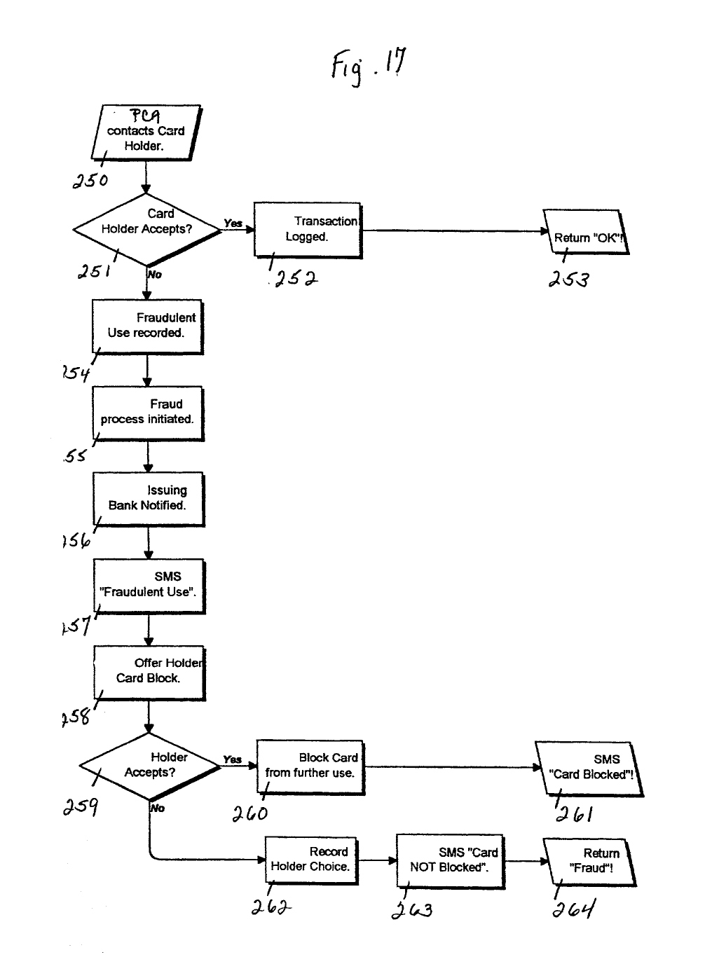

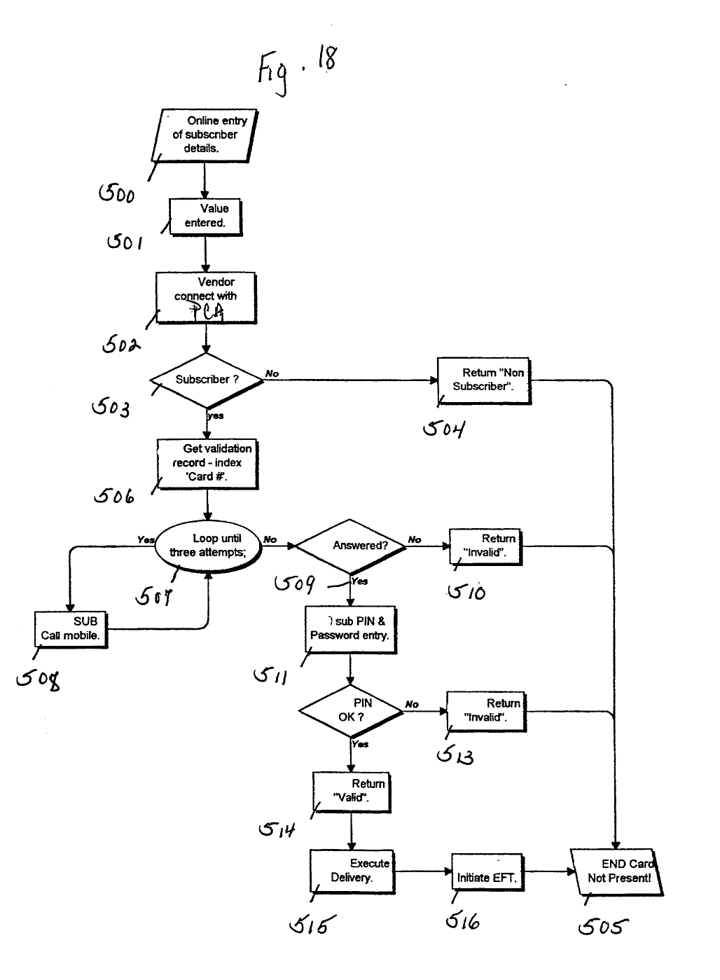

In one embodiment, if the Fraudulent Activity Function is activated by the subscriber in the PCA system (70), the PCA system indicates that fraudulent use of the payment card has been identified by the PCA system or the subscriber. The PCA system does not approve a payment transaction when the Fraudulent Activity Function has been activated and sends an SMS message to the subscriber's mobile phone indicating fraudulent activity has been detected (71). The Fraudulent Activity Function is described in further detail herein with reference to FIG. 17.

Each payment transaction that the PCA system fails to approve due to the Pre-Blocking, Predetermined Limit or Fraudulent Activity Functions is returned to and the transactions details recorded in the PCA central database (15).

Referring to FIG. 6, in one embodiment, a method of verifying the identity of the card user also includes a subprocess of verification of the existence of the subscription of the subscriber with the PCA system. The subscription of the subscriber is confirmed by the PCA system (84) by verifying that the account number provided to the PCA system by the subscriber corresponds with the mobile phone number registered by the subscriber in the Registration Process, described herein with reference to FIG. 4c, and stored in the validation record of the central database. If the account number provided by the card user does not correspond to a registered mobile phone number, the account number is returned as a non-subscriber (82). The authorization process of the payment transaction is then routed to the card issuer or the card issuer's authorization systems for further approval of the payment transaction. If the account number provided to the PCA system is matched with the registered mobile phone number of the subscriber stored in the validation record of the central database, then the PCA system continues the process of approval of the payment transaction by obtaining the subscriber data (83).

The PCA system continues the approval process by activating one or more Subscriber Service Functions selected by the subscriber. The PCA system provides a variety of Subscriber Service Functions including, although not limited to, a Subscriber Service Function that deactivates the PCA system or renders the PCA approval process “OFF” (84). An SMS message is issued to the subscriber to indicate that the PCA system is “OFF” (85). Another Subscriber Service Function is a Hot Card Function that enables the PCA system to send an SMS message (“HOT CARD”) (87) to the subscriber indicating that the card issuer has “hot listed” the payment card in instances of loss or theft of the payment card (86).

In other embodiments of the methods according to the invention, additional Subscriber Service Functions are provided by the PCA system that include various levels of payment transaction control and or customization of the manner of authorization of payment transactions. Such Subscriber Service Functions include an All Transactions Function (89), whereby the PCA system contacts the subscriber for every payment transaction sent to the PCA system for card user validation and payment transaction authorization, described herein in further detail with reference to FIG. 7; a Pre-Authorization Function (90), whereby the PCA system authorizes payment transactions for a period of time predetermined by the subscriber, described herein in further detail with reference to FIG. 8; a Pre-Blocking Function (91), whereby the PCA system blocks authorization of payment transactions for a period of time predetermined by the subscriber, described herein in further detail with reference to FIG. 9; and a Standing Order Function (92), whereby the PCA system authorizes payment transactions in accordance with a Standing Order prescribed by the subscriber, described herein in further detail with reference to FIG. 10.

Each of the Subscriber Service Functions selected and activated in the PCA system by the subscriber determines how a payment transaction is approved by the PCA system (93). If the PCA system approves a payment transaction in accordance with one or more Subscriber Service Functions, the PCA system allows the payment transaction to proceed and the PCA system indicates the transaction is accepted (94). The payment transaction may be subsequently routed to the card issuer's authorization systems for further authorization. If a payment transaction is not approved by the PCA system in accordance with one or more Subscriber Service Functions, the transaction is returned as refused (95).

Referring to FIGS. 7-10, various Subscriber Service Functions of the PCA system provide different types and levels of authorization of payment transactions in accordance with criteria elected by the subscriber through the selection and activation of one or more Subscriber Service Functions. As shown in FIG. 7, the All Transactions Function is activated in the PCA system (100) to permit the PCA system to contact the subscriber on every occasion on which the validation of the subscriber and authorization of a payment transaction is sought. The details of the payment transaction are sent to the PCA system (101). The subscriber's mobile phone is contacted by the PCA system (102) to verify the PIN code and password. If the mobile phone is not answered (103), then the mobile phone is redialed (104) by the PCA system. If the mobile phone is not answered after the third redial (105), the PCA system sends a SMS message to the subscriber's mobile phone (106) and the payment transaction is returned by the PCA system as a rejected transaction (107). If the mobile phone is answered (103) by the subscriber, the Interactive Voice Response (IVR) module greets the subscriber and requests the subscriber's PIN code and password (108). If the PIN code provided by the subscriber is verified by the PCA system (109), the PCA system updates and records the payment transaction (110), and an SMS message is sent to the subscriber's mobile phone including details of the payment transaction and a result of an attempt for transaction authorization (111). The authorization for the payment transaction is returned to the PCA system as accepted (112) The payment transaction may then be routed to the card issuer's authorization systems for further authorization of the payment transaction. If the PIN code provided by the subscriber is not verified by the PCA system (109) after three attempts to verify the PIN code (113), the PCA system suspends the subscriber account (114) and sends an SMS message to the subscriber's mobile phone indicating that the account has been suspended (115) and an authorization for the payment transaction is returned as rejected (107).

As shown in FIG. 8, the Pre-Authorization Function (120) is selected and activated in the PCA system via a set-up process when the subscriber wishes to pre-authorize payment transactions for a predetermined period of time. Selecting a time period for pre-authorization of payment transactions by the PCA system includes entering into the PCA system during the set-up process a Time Value, such as a number of hours and or days, indicating the period during which the PCA system may authorize payment transactions without the validation transaction to verify the subscriber's identity. The Time Value may be entered into the PCA system by keying the Time Value into the keypad of a mobile phone (121). The PCA system verifies the Time Value (122). If the Time Value is not satisfactory according to the PCA system, the PCA system sends an SMS message to the subscriber's mobile phone indicating that the Time Value is refused (123), and the process is returned as refused (124). If the Time Value is satisfactory, the subscriber is authorized to enter the hours and or days representing the Time Value (125). The PCA system then requests the subscriber to select a Start Time at which the PCA system is to begin pre-authorization of payment transactions (126). If the Start Time entered by the subscriber is not satisfactory according to the PCA system, the PCA system sends an SMS message to the subscriber's mobile phone indicating the Start Time is refused (123) and the process is returned as refused (124). If the Start Time is not to begin immediately but at a later time, the PCA system requests the subscriber enter the number of hours and or days within which the PCA system is to begin pre-authorization of payment transactions (128). Similarly, if the hours and or days selected as the Start Time are satisfactory according to the PCA system (129), then the PCA system sends an SMS message to the subscriber's mobile phone indicating that the pre-authorized status is achieved (130) and the response is returned as pre-authorized (131). If the hours and or days of the Start Time selected are not satisfactory (129), the PCA system sends an SMS message to the subscriber's mobile phone (123) and the process is returned as refused (124). If the subscriber selects that the pre-authorization Start Time to begin immediately (127), then the PCA system sends the subscriber's mobile phone an SMS message indicating that the pre-authorization status has been achieved (130), and the response is returned as pre-authorized (131).

For the duration of the pre-authorization period activated by the Pre-Authorization Function of the PCA system, the payment card account number by-passes the PIN and password verification of the payment transaction authorization process of the PCA system.

The Pre-Authorization Function, therefore, does not require the subscriber to be in possession of a mobile phone for validation of the card user and authorization of the transaction at the time any payment transaction seeks authorization from the PCA system during this time period. However, a record or a textual summary of all pre-authorized payment transactions is recorded and stored in a text messaging box of the mobile phone of the subscriber. The subscriber is alerted by an SMS message subsequent to each transaction seeking authorization which indicates the payment transaction details, including merchant/retailer name, total amount of transaction, time and date of transaction, and transaction status. The Pre-Authorization Function provides less security and greater susceptibility to fraudulent use of the payment card. The subscriber is informed by the PCA system of the additional risk of fraudulent use of the payment card in the Pre-Authorization Function when this function is selected and activated. In addition, the Pre-Authorization Function provides a less secure level of payment transaction authorization. At any time during the Pre-Authorization period, however, the subscriber may cancel this function and restore the payment card, for instance, to the All Transactions Function that requires the PCA system's authorization each time authorization of a payment transaction is sought.

The Pre-Authorization Function, however, has many advantages including efficiently providing the subscriber with the record or textual summary of transactions for reviewing the details regarding each transaction payment authorization. The subscriber may check such a Pre-Authorization record daily, or at any time the subscriber wishes, by accessing the text messaging box that stores the record in the mobile phone. The SMS messages are generated and sent after each payment transaction authorization, thereby efficiently and frequently updating the subscriber of the Pre-Authorization transactions. The SMS message record includes the details of authorized payment transactions since the last time the subscriber checked the record or the record was accessed by the subscriber.

The Pre-Authorization Function favors the subscriber in the country in which the payment card and the mobile phone are registered, since the PCA system depends upon a level of network coverage in each country in which the PCA cardholding subscriber tenders the payment card for payment of transactions. Once the payment card has been tendered and the transaction seeks payment authorization, the authorization module of the payment card issuer is accessed for verification of the payment transaction, as is the PCA system contacted. Should the subscriber experience authorization difficulties in countries other than the country in which the payment card and the mobile phone are registered, the subscriber may activate the Pre-Authorization Function or select a longer period of time for pre-authorization of payment transactions to avoid such authorization difficulties.

The Pre-Authorization Function of the PCA system also provides the advantage of monitoring payment card transactions and providing a level of security during use of the payment card. As the Pre-Authorization Function provides the record or the textual summary of all pre-authorized transactions by receipt and storage of SMS messages in the mobile phone, the subscriber may personally review each pre-authorized payment transaction immediately after it has been authorized or when each pre-authorized payment transaction is received during the validation process seeking authorization. The subscriber may elect to personally authorize a payment transaction or to allow the Pre-Authorization Function to authorize the transaction. In some instances, the subscriber may want to personally authorize a transaction, for example, if the transaction amount is high. Since the subscriber may review the payment transactions seeking authorization as they are received, the subscriber is given the flexibility of monitoring transactions. If the subscriber believes that a transaction seeking authorization is fraudulent, the subscriber may block the payment card in the PCA system by activating the Hot Card Function that alerts the PCA system and the card issuer of potential fraudulent use. In addition, upon receipt of an SMS message, the subscriber may elect to store or delete the SMS message received. In this respect, the Pre-Authorization Function operates as an alerting process to identify the details of pre-authorized payment transactions prior to authorization or subsequent to authorization by review of incoming SMS messages or the record established by stored SMS messages of the pre-authorized payment transaction details.

As shown in FIG. 9, the Pre-Blocking Function (140) is selected and activated in the PCA system by the subscriber via a set-up process when the subscriber wishes to pre-block payment transactions for a period of time. Selecting the Pre-Block Function includes entering into the PCA system a Time Value during the set-up process, as described above, in hours and or days during which payment transactions are to be pre-blocked by the PCA system (141). The Time Value may be entered into the PCA system by providing the number of hours and or days via the keypad of the subscriber's mobile phone. The PCA system similarly verifies the Time Value. If the Time Value is not satisfactory, an SMS message is sent to the subscriber's mobile phone indicating that the time value is refused (143) and the process is returned as refused (144). If the Time Value is satisfactory (145), the subscriber is requested to select a Start Time during which the PCA system pre-blocks payment transactions (146). If the Start Time entered is satisfactory (146), an SMS message is sent to the subscriber's mobile phone (143) and the process is returned as refused (144). If the Start Time of the Pre-Block Function is not to begin immediately, but at a later time, the subscriber is requested by the PCA system to enter the hours and or days within which the PCA system is to begin blocking payment transactions (148). If the Start Time is satisfactory, an SMS message is sent to the subscriber's mobile phone indicating that the Pre-blocked status is enacted (150) and the response is returned as pre-blocked (151). If the Start Time is not satisfactory, an SMS message is sent to the subscriber's mobile phone (143) and the process is returned as refused (144). The subscriber may indicate that the Start Time of the Pre-block functionality is to occur immediately, whereby an SMS message is sent to the subscriber's mobile phone indicating that the Pre-blocked status is in effect (150) and the response is returned as pre-blocked (151).

During the duration of the Pre-Blocking Function, the PCA system will not provide authorization for payment transactions and prevent use of the subscriber's account. The PCA system continues to alert the subscriber during the period during which the Pre-Blocking Function is activated by SMS messages sent to the subscriber's mobile phone. The Pre-Blocking Function helps to provide a level of security to the subscriber's account to prevent fraudulent activity on the account.

As shown in FIG. 10, the Standing Order Function is selected and activated in the PCA system by the subscriber when the subscriber wishes to use an account to pay a standing order. The subscriber elects the Standing Order Function (160) and provides and approves the details of the standing order in a Set Up process conducted by the PCA system (161). When the PCA system is contacted to pay the standing order, the PCA system checks the details of the standing order (162). If all the details of the standing order are as previously approved by the subscriber, the PCA system sends an SMS message to the subscriber's mobile phone (163) informing the subscriber that the Standing Order transaction is approved and the authorization is returned as approved (164). The PCA system offers an Optional Call-Up function for the Standing Order Function for selection by the subscriber (165), whereby the PCA system contacts the subscriber's mobile phone to authorize the Standing Order payment transaction (166), such as by manually keying in the subscriber's PIN code in the mobile phone (167). Upon successful approval, the PCA system sends an SMS message to the subscriber's mobile phone (163) and the authorization is returned as approved (164). An unsuccessful approval of the Standing Order payment transaction by the PCA system activates the PCA system to send an appropriate SMS message (169) and the authorization is returned as rejected (168). If the Standing Order details are incorrect and the Optional Call-up function in not activated in the PCA system, then the PCA system sends the subscriber an SMS message confirming the Standing Order payment rejection (169) and the authorization is returned as rejected (168).

Referring to FIG. 11, the methods according to the invention of selecting, setting and activating the various functions provided by the PCA system enables the subscriber to customize the services provided by the PCA system to tailor the type and level of authorization of payment transactions to meet the subscriber's preferences and lifestyle, as well as to control the level of security of authorization of payment card transactions desired. The subscriber initiates contact with the PCA system (170). In one embodiment, initial contact with the PCA system is accomplished by the subscriber calling the PCA system on a registered mobile phone. The PCA system requests the subscriber key in to a keypad of a mobile phone the subscriber PIN code and to recite the password. The PIN code and password are checked and verified by the PCA system through comparison of the subscriber data provide with the validation record stored in the central database. If the PCA system verifies the PIN code, the PCA system provides the subscriber with a Menu (175). If the PIN code is not verified, the PCA system sends an SMS message to the subscriber's mobile phone indicating that the PIN code has been refused (173) and the function response is returned as refused (174). The Menu allows the subscriber to select a Value that represents one of the PCA system functions (176). The subscriber then proceeds through the Menu (177) to initiate one of the methods described above to select and activate the function. Once contact with the PCA system is terminated, the subscriber receives from the PCA system an SMS message to acknowledge the function that has been activated (178) and the response is returned as activated (179). If an incorrect Value is sent to the PCA system (176), the IVR module alerts the subscriber that the Value entered is incorrect and the PCA system offers an opportunity to the subscriber to enter a correct Value each time an incorrect Value is entered. An SMS message is sent to the subscriber's mobile phone by the PCA system upon failure to activate a function to indicate that activation has failed and the transaction is returned as refused (174).

Referring to FIG. 12, in one embodiment, a method by which the Pre-Authorization Function authorizes payment transactions for a pre-determined period of time (180) is shown, whereby the subscriber payment card account is presented to the PCA system for authorization of a payment transaction. The Values provided by the subscriber in the set up process of the Pre-Authorization Function [as shown in FIG. 8,] are checked by the PCA system (182). If details of the payment transaction fall within a range of the preset Values on record with the PCA system, then an SMS is sent indicating that the payment transaction has been approved (183) and the transaction is returned as approved (184). If a discrepancy results between the details of the payment transaction and the pre-set Values on record with the PCA system, the PCA system provides the subscriber with an option in the Set-up Process of the Pre-Authorization Function to ask to be contacted in such situations, for example, by calling the subscriber's mobile phone (186). If the subscriber receives a call from the PCA system, the subscriber may approve the payment transaction values with the PCA system, for instance, by keying in approval on the keypad of their mobile phone (187) The PCA system sends an SMS message to the subscriber's mobile phone indicating that the payment transaction is approved (183) and the transaction is returned as approved (184). If the call is not answered by the subscriber (186), then manual approval is not achieved and an SMS message is sent to the subscriber's mobile phone indicating that the payment transaction has not been approved (188) and the transaction is returned as rejected (189).

Referring to FIG. 13, in one embodiment, a method by which the Pre-Blocking Function activates the PCA system to block payment transactions is shown (190). The PCA system is provided Values of a predetermined period of time by the subscriber in this set-up process, as shown in FIG. 9, that represent the number of hours and or days of duration that the Pre-Blocking Function is to be active in the PCA system (191). The subscriber is queried by the PCA system if the Pre-Blocking period starts immediately (195). If the Pre-Blocking period starts immediately, an SMS message is sent indicating that payment transactions will be blocked (198) and returned as blocked (199). If the subscriber wishes the Pre-Blocking period to start at a later time, the subscriber is asked to enter a number of hours and or days within which the Pre-Blocking Function is to begin (196). The number of hours and or days is checked by the PCA system (197) and if the number selected is verified by the PCA system, an SMS message is sent to the subscriber's mobile phone (198) and returned as blocked (199). However, if the number of hours and or days entered is not verified by the PCA system as acceptable, then the subscriber is asked to select a valid number of hours and or days (197). Should the PCA system fail to verify or accept the selection of a number of hours and or days after three attempts, the subscriber is advised to call for service. An SMS message is sent indicating that the attempts to activate the Pre-Blocking Function were refused (193) and the response is returned as refused (194).

Referring to FIG. 14, in one embodiment, when the subscriber wishes to deactivate the PCA system (“Switch-Off”), the PCA system asks the subscriber to select an OFF Function in the Menu (200). If the option is valid, the PCA system will ask subscriber to select a start time for deactivation (201). If the start time is to begin immediately (205), an SMS message is sent that the PCA system is deactivated (“OFF”) (208). If the subscriber wishes to start the OFF Function at a later time, the PCA system asks the subscriber to select the number of hours and or days within which the OFF Function is to begin (206). The number of hours and or days selected are verified by the PCA system (207). If the number of hours selected is verified, then an SMS message is sent that the OFF Function will begin after a lapse of a predetermined number of hours and or days (208) and a record is returned that the PCA system is OFF (209). If the number of hours and or days selected by the subscriber is determined to be invalid (207), then the subscriber has two further attempts to select the number of hours and or days of the OFF Function (206). If the subscriber fails after three attempts to select a valid number of hours and or days, an SMS message is sent indicating that an attempt to activate the OFF Function was attempted (203) and refused (204).

Referring to FIG. 15, when a payment transaction is received by the PCA system during the OFF Function (210), the PCA system immediately routes the payment transaction to the card issuer's authorization systems without the approval of the PCA system (216A). An SMS message is sent indicating that the OFF Function is activated (215) and returned as the PCA system OFF (216). The first three payment transactions that are received and recorded by the PCA system subsequent to activation of the OFF Function provide an SMS message (215) and return as the PCA system OFF (216). Thereafter, the account of the subscriber reverts back to its status prior to activation of the account with the PCA system and the next payment transaction is returned as PCA system OFF (216).

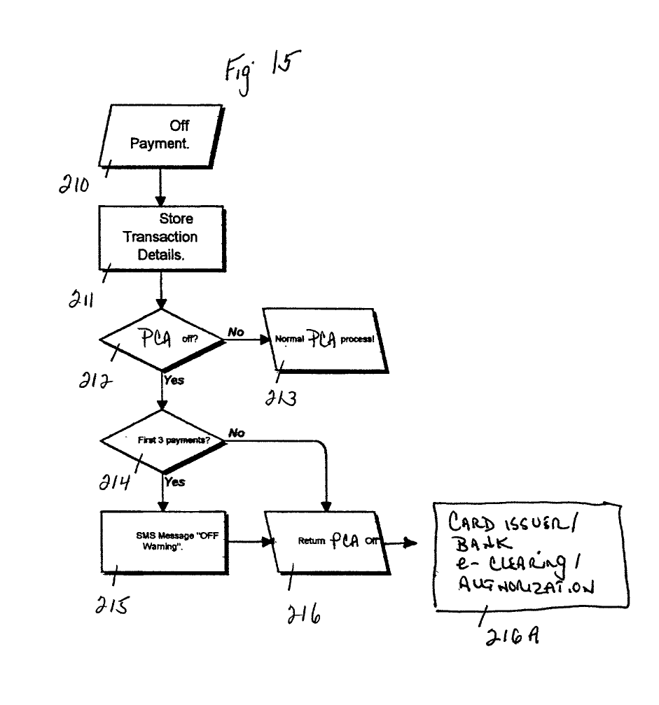

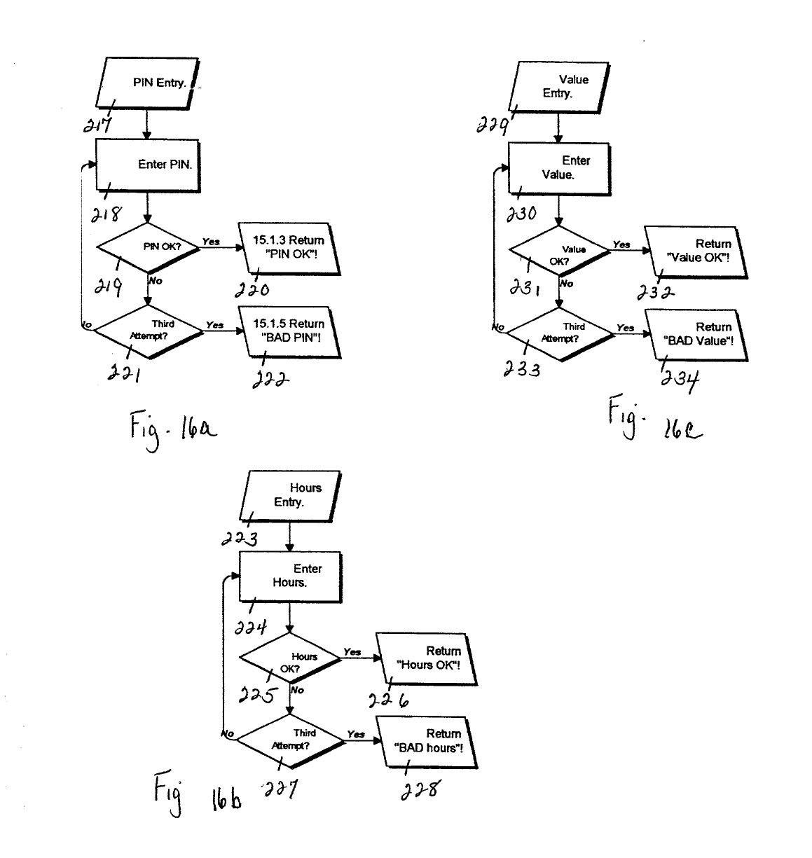

Referring to FIGS. 16a-16c, common processes used by the subscriber to activate various functions in the PCA system include entering data in the PCA system, such as, but not limited to, entering a PIN code number, entering a number of hours in connection with activation and duration of various authorization functionalities, and entering a value in connection with particular pre-set value limits.

As shown in FIG. 16a, the process of PIN code entry includes entering the PIN code in the PCA system (218) followed by verification of the PIN code by the PCA system (219). Depending upon whether or not the PCA system verifies the PIN code, the PCA system either returns the procedure indicating that the PIN code provided is valid (“PIN OK”) (220) or returns the procedure indicating that the PIN code is invalid (“BAD PIN”) (222). Two further attempts after an initial unsuccessful PIN code entry are provided by the PCA system (221) before the procedure is returned indicating the PIN code is not valid (222).

Similarly, as shown in FIGS. 16b and 16c, the process of entering a number of hours and or days, or other specific value, for activation of various functions of the PCA system include entry of a number (224) or a value (230). As shown in FIG. 16b, a number of hours and or hours is either verified by the PCA system (225) and a response provided indicating that the number is valid (“HOURS OK”) (226), or found invalid and a response provided indicating that the number is invalid (“BAD HOURS”) (228). Similarly, as shown in FIG. 6c, a pre-set value is either verified (231) and a response provided indicating that the pre-set value is valid (“VALUE OK”) (232), or found invalid and a response provided indicating that the value is invalid (“BAD VALUE”) (234). The PCA system provides two additional attempts to enter a valid number hours and or days (227) or a preset value (233) before responding that the entry provided is invalid (228) (234).

Referring to FIG. 17, in one embodiment, a method of Fraud Notification is initiated by the PCA system if either the subscriber, the PCA system or the card issuer has previously identified and recorded with the PCA system that the account has been fraudulently used. Typically, the PCA system contacts the subscriber via the subscriber's mobile phone on each occasion the payment card or account number is sought for payment of a transaction (250). Upon contact by the PCA system, the subscriber either accepts or rejects the transaction for which payment authorization (251). If the subscriber accepts the transaction, the transaction is logged in the central database of the PCA system (252) and the transaction is returned indicating acceptance (253). If either the subscriber, the PCA system or the card issuer has previously identified and recorded fraudulent use of the payment card (254), the PCA system initiates the Fraud Notification process (255). The PCA system notifies the card issuer of fraudulent use (256) and offers the subscriber the opportunity to block future use of the account or card (258). If the subscriber accepts the opportunity to block future use of the card (259), then the PCA system blocks future use of the card. An SMS message is sent by the PCA system indicating that use of the card is blocked (261). However, if the subscriber does not accept the opportunity to block future use of the card (259), then the subscriber's choice not to block future use of the card is recorded with the PCA system (262). An SMS message is sent indicating that future use of the card has not been blocked (263) and the transaction is returned indicating Fraud (264).

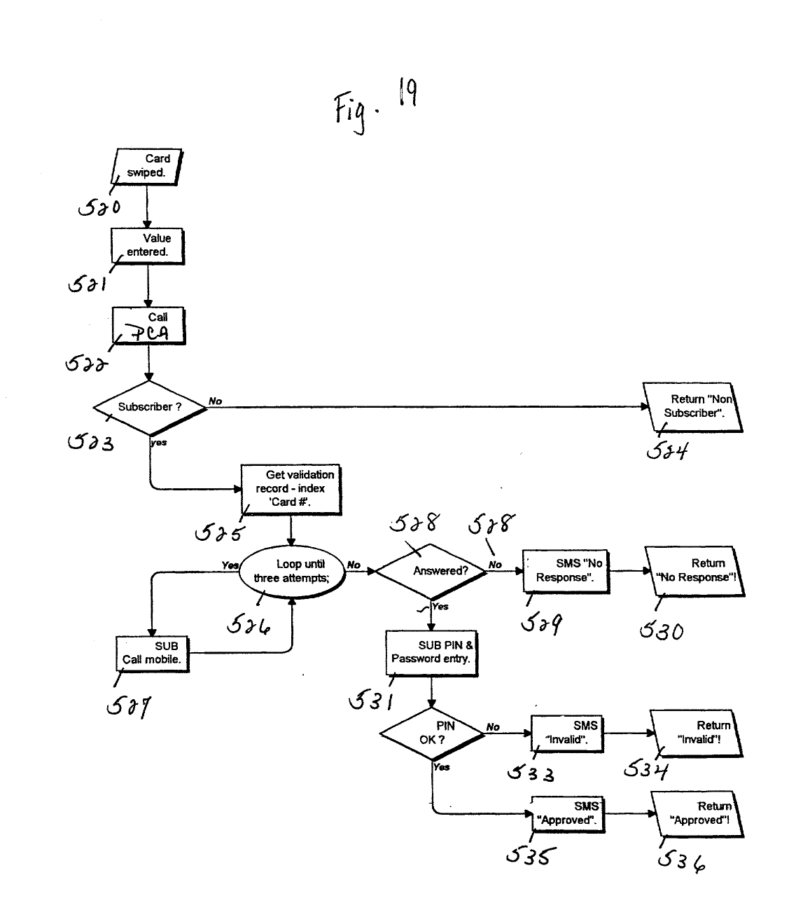

Referring to FIG. 18, in one embodiment, a method of authorization by the PCA system for a payment transaction enacted in a “Card Not Present” environment is shown. In instances in which the card is not present, for instance with online Internet, MOTO or keyed transactions (500), the value of the transaction is entered online (501) and the vendor is connected (502) to the PCA system. The PCA system checks the account number provided with the central database (503). If the account is not a registered subscriber of the PCA system, the PCA system will return the transaction as “Non Subscriber” (504). If the account is validated by the PCA system as a registered subscriber, the PCA system accesses the validation record of the central database (506) and the mobile phone number of the subscriber is contacted by the PCA system (508). Three attempts are made by the PCA system to contact the mobile phone of the subscriber (507). If the mobile phone is not answered after three attempts, the PCA system returns the transaction as “Invalid” (510). Once the call is answered by the subscriber (509), the PCA system requests the subscriber enter the PIN code and password (511). If the PIN code entered is not valid, then the PCA system returns the transaction as “Invalid” (513). If the PIN code entered is valid, then the PCA system returns the transaction as “Valid” (514). Once delivery is executed by the PCA system (515), the Electronic Funds Transfer (EFT) is initiated (516) and the Card Not Present transaction ends (505).

Referring to FIG. 19, in one embodiment, a method of authorization by the PCA system for a payment transaction enacted by a “Card Present” environment is shown. The card is swiped at a point-of-sale (520) for account authorization. The value of the transaction is entered (521) and the PCA system is contacted (522). As in a “Card Not Present” transaction described above in reference to FIG. 18, the account is verified for subscribership (523)-(525). Once the subscriber is verified, the PCA system activates the validation record of the central database (525) and the mobile phone of the subscriber is called (527), allowing three attempts to contact the subscriber (526). If the mobile phone is not answered (528), then an SMS message is sent indicating “No Response” (529) and the transaction is returned “No Response” (530). If the mobile phone is answered (528), the subscriber is requested to enter the correct PIN code and to speak the password into the mobile phone (531). If the PIN code entered is not OK, then an SMS message is sent (533) indicating that the PIN code is “Invalid” and the transaction is returned as “Invalid” (534). If the PIN code entered is OK, then an SMS message is sent (535) as “Approved” (535) and the transaction is returned as “Approved” (536).

As described above, the PCA system is contacted each time the payment card of the authorized cardholder or subscriber is tendered for payment of a transaction. If the PIN code is entered incorrectly by the card user when the subscriber's mobile phone is called by the PCA system for PIN code and vocal password verification, the validation transaction may be repeated a maximum of two additional times upon request by the PCA system for the card user to enter the PIN code. Upon three failed attempts to enter the PIN code by the card user, the payment card is automatically confiscated by an ATM or retained by a merchant, or in the case of an online payment, the payment card will be blocked for all further use in payment transactions. A file is sent by the PCA system to the card issuer, indicating the results of the failed validation transactions, and the card issuer will act in accordance with the card issuer's procedure for failure of correct PIN code entry.

If an unauthorized party intercepts the payment card, that unauthorized card user may attempt to carry out the validation transaction required for payment card transaction authorization by the PCA system. However, without entry of the correct PIN code issued by the PCA system or the card issuer, the chances that the validation transaction will be successful are remote. If the unauthorized cardholder attempts to use the payment card, for instance, in a merchant point-of-sale transaction that falls below a maximum level allowed for unauthorized payment transactions, then the potential exists for a successful outcome to the fraudulent attempt to use the payment card. The “floor limit” of unauthorized transactions may be adjusted by the card issuer or the merchant or retailer in order to prevent additional fraudulent attempts to use the payment card for any transaction amount over this “floor limit” by forcing payment card transactions above the “floor limit” to be authorized by the PCA system. Card issuers, merchants and retailers will, thus, be made aware of the unauthorized nature of the payment card or BIN number presented for payment.

In order to force each newly issued payment card to be validated or acknowledged by the PCA system, a service code applied to the magnetic stripe of payment cards for “card present” point-of-sale devices may be set to force the payment card to be validated and authorized by the PCA system each and every time the payment card comes into contact with an “Electronic Funds Transfer Point of Sale device (EFTPOS). This method of contacting the PCA system would allow merchants and retailers, who have upgraded their point-of-sale terminals to EFTPOS, to benefit from added security and greater protection against fraudulent use of payment cards. Application of a service code would also provide benefits of added security and greater protection to card issuing banks, who have upgraded their terminal infrastructure in order to accommodate the different service codes which dictate to merchant/retailer systems, to force certain payment cards to go on-line real time for payment card authorization. Merchants and retailers who have not upgraded their authorization systems to accept payment cards for real time authorization are left vulnerable to fraudulent use of payment cards, particularly if merchants and retailers depend upon payment transaction authorization subsequent to the actual time the payment transaction takes place.

While card issuers, such as merchants, retailers and card issuing banks and financial institutions, may wish to incorporate the PCA system and the method of the invention into their existing authorization systems, the PCA system will require the subscription of such card issuers which includes the addition of a new authorization module to their existing authorization processing modules or systems. The PCA system, as described above, includes the central database for setting of the validation record which serves as the authorization template for all payment card transactions. The central database may be linked to or accessed from various card payment options as described above, including a personal computer, an Internet access device, a point-of-sale device, or a land-based or mobile phone or a personal digital assistant. The central database, upon authorization of payment transactions, routes such payment transactions to additional authorization modules and systems used by card issuers for further authorization of transactions.

In the case of a land-based or mobile phone being used for payment of a transaction, the payment card number may be verbally supplied by the subscriber. However, the correct PIN code issued by the PCA system or the card issuer will need to be manually entered on the keypad of the land-based or mobile phone to validate the identity of the card user as the authorized cardholding subscriber and to authorize payment of the transactions. Thus, telephone Mail Order Phone Order (MOTO) retailers and merchants will have for the first time a unique benefit of real time verification of a card user and authorization of payment of the telephone transaction within seconds of the transaction or order being taken. Such MOTO retailers and merchants have the advantage of the added security provided by voice recognition technology implemented by the PCA process, if such MOTO retailers and merchants subscribe to the voice link verification of the PCA system. The voice link verification provided by the PCA system is specifically designed for the “card not present” environment, but, most particularly, for MOTO retailers and merchants providing verifiable real time authorization of phone- made payment card transactions.

Although the investment in mobile phones by the payment cardholder may be deemed a worth while expenditure by payment cardholders who wish to register and participate in the validation and authorization of payment transactions provided by the PCA system and the method according to the invention, card issuers would not experience a great financial investment in new equipment and hardware in order to subscribe to and participate in the PCA system and the method of the invention to achieve the added security of payment card use and the reduced level of unauthorized and undetected fraudulent use of payment cards provided by the invention.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

1. A method for providing security to payment card transactions comprising:
receiving information designating an account of a payment cardholder;
in response to receiving account information, forwarding a request over a communications system to a mobile telephone of the payment cardholder for information identifying one or more authorized users of a payment card;
receiving information identifying one or more payment card users from the mobile telephone of the payment cardholder;
in response to receiving payment card user identifying information, creating a validation record associated with the payment cardholder account and one or more authorized payment card users; and
setting the validation record to authorize payment card transactions with use of a payment card by an authorized payment card user.

2. The method of claim 1, wherein the communications system includes a short messaging service using a short messaging transport protocol for forwarding a request to a mobile telephone of a payment cardholder as a text message.

3. The method of claim 1, wherein receiving information identifying one or more payment card users includes receiving a verbal password associated with one or more authorized payment card users.

4. The method of claim 1, wherein receiving information identifying one or more payment card users includes receiving a verbal password and a personal identification code associated with one or more authorized payment card users.

5. The method of claim 1, wherein receiving information identifying one or more payment card users includes receiving a verbal password, a personal identification code and a mobile telephone number associated with one or more authorized payment card users.

6. The method of claim 1, wherein receiving information designating an account of a payment cardholder includes receiving information from an access device selected from the group consisting of a land-based telephone, a personal computer, a personal digital assistant, an automated teller machine (ATM) and an Internet access device.

7. The method of claim 1, wherein creating a validation record includes recording a verbal password associated with one or more authorized payment card users.

8. The method of claim 7, wherein setting the validation record includes verifying a verbal password provided by a payment card user is similar to a verbal password recorded in the validation record and associated with one or more authorized payment card users.

9. The method of claim 7, wherein creating the validation record further includes creating a validation record in a database.

10. The method of claim 9, wherein the method further comprising providing access by a payment cardholder to the database, receiving information from the payment cardholder, and storing the information in the database.

11. The method of claim 10, wherein receiving information from a payment cardholder and storing the information in the database includes receiving and storing information in the database for pre-authorizing one or more payment card transactions of one or more authorized payment card users for a predetermined period of time.

12. The method of claim 10, wherein receiving information from a payment cardholder and storing the information in the database includes receiving and storing information in the database for blocking one or more payment card transactions of one or more authorized payment card users for a predetermined period of time.

13. The method of claim 10, wherein receiving information from a payment cardholder and storing the information in the database includes receiving and storing information in the database for pre-authorizing one or more payment card transactions of one or more authorized payment card users within a predetermined transaction value limit.

14. The method of claim 10, wherein receiving information from a payment cardholder includes receiving information from a mobile telephone.

15. A method for authorizing payment card transactions comprising:
receiving information designating an account of a payment card transaction;
in response to receiving account information, forwarding a request over a communications system to a mobile telephone of the payment cardholder for information identifying one or more payment card users;
receiving information identifying one or more payment card users from the mobile telephone of the payment cardholder;
in response to receiving identifying information, retrieving a validation record associated with the cardholder account and one or more authorized payment card users;
determining whether a status of a payment card user is one of authorized and unauthorized by reconciling information received identifying one or more payment card users with the validation record; and
completing the payment card transaction according to an authorization status of the payment card user.

16. The method of claim 15, wherein the communications system includes a short messaging service using a short messaging transport protocol for forwarding a request to a mobile telephone of a payment cardholder as a text message.

17. The method of claim 15, wherein receiving information designating an account of a payment card transaction includes receiving information from an access device selected from the group consisting of a land-based telephone, a personal computer, a personal digital assistant, automated teller machine (ATM) and an Internet access device.

18. The method of claim 15, wherein receiving information identifying one or more payment card users includes receiving a verbal password associated with one or more authorized payment card users.

19. The method of claim 15, wherein receiving information identifying one or more payment card users includes receiving a verbal password and a personal identification code associated with one or more authorized payment card users.

20. The method of claim 15, wherein retrieving a validation record includes retrieving a validation record from a database.

21. The method of claim 20, wherein the method further comprising providing access by a payment cardholder to the database, receiving information from the payment cardholder, and storing the information in the database.

22. The method of claim 21, wherein receiving information from a payment cardholder and storing the information in the database includes receiving and storing information in the database for pre-authorizing one or more payment card transactions of one or more authorized payment card users for a predetermined period of time.

23. The method of claim 21, wherein receiving information from a payment cardholder and storing the information in the database includes receiving and storing information in the database for blocking one or more payment card transactions of one or more authorized payment card users for a predetermined period of time.

24. The method of claim 21, wherein receiving information from a payment cardholder and storing the information in the database includes receiving and storing information in the database for pre-authorizing one or more payment card transactions of one or more authorized payment card users within a predetermined transaction value limit.

25. The method of claim 21, wherein receiving information from a payment cardholder includes receiving information from a mobile telephone.

26. The method of claim 15, wherein completing payment card transactions according to an authorization status of the payment card user includes notifying the payment cardholder of the status of the payment card user.

27. The method of claim 26, wherein notifying the payment cardholder of the status of the payment card user includes forwarding a text message to a mobile telephone of the payment cardholder by a short message service using a short messaging transport protocol.

28. A system for providing information to identify and authorize a payment card user in a payment card authorization system comprising:
a central manager including a database to record and store information identifying a plurality of payment cardholders and payment card users of the authorization system;
the central manager coupled to a Short Message Service module to forward text messages to payment cardholders via mobile telephone; and
the central manager further coupled to a Voice Recognition module and an Interactive Voice Recognition module for voice communication between the central manager and payment cardholders and payment card users via mobile telephone.

29. The system of claim 28, wherein the central manager operates as a software module operating on one or more computers.

30. The system of claim 28, wherein the central manager is further coupled to one or more credit authorization systems.
